(19) United States
(12) Patent Application Publication
(10) Pub. No.: US 2025/0124480 A1
(43) Pub. Date: Apr. 17, 2025

(54) SYSTEMS AND METHODS FOR AUTOMATIC CLAIMS SETTLEMENT

(71) Applicant: Synchrony Bank, Stamford, CT (US)

(72) Inventors: Jake Miller, Stamford, CT (US); Joseph Gauthier, Stamford, CT (US); Nicholas White, Stamford, CT (US)

(21) Appl. No.: 18/915,441

(22) Filed: Oct. 15, 2024

Related U.S. Application Data
(60) Provisional application No. 63/590,926, filed on Oct. 17, 2023.

(51) Int. Cl. G06Q 30/04; G06Q 20/38

(52) U.S. Cl. CPC G06Q 30/04; G06Q 20/385

(57) ABSTRACT

Systems and methods provide a framework through which automatic reimbursement for adjudicated claims is performed through dynamic evaluation of claims and of available reimbursement methods. In response to a reimbursement request, a system, through dynamically trained machine learning algorithms, can dynamically generate different reimbursement method recommendations. For a selected reimbursement method, the system can further automatically interact with different payment instrument services to ensure that corresponding payment instruments can be used for the reimbursements. This interaction can be facilitated through the use of tokenized payment instruments provided by these payment instrument services.

### CROSS-REFERENCE TO RELATED APPLICATIONS

The present patent application claims the priority benefit of U.S. Provisional Patent Application No. 63/590,926 filed Oct. 17, 2023, the disclosure of which is incorporated herein by reference.

### FIELD

The present disclosure relates generally to a framework through which automatic reimbursement for adjudicated claims is performed through dynamic evaluation of claims and of available reimbursement methods.

### SUMMARY

Disclosed embodiments provide a framework for the automatic reimbursement of adjudicated claims through dynamic evaluation of claims and of different available reimbursement methods. According to some embodiments, a computer-implemented method is provided. The computer-implemented method comprises receiving a reimbursement request. The reimbursement request includes an invoice and account information corresponding to a payment instrument. The computer-implemented method further comprises processing the invoice to determine a reimbursement amount for the reimbursement request. The computer-implemented method further comprises transmitting a balance information application programming interface (API) call corresponding to the reimbursement request. The API call includes the account information. The computer-implemented method further comprises receiving a transaction token and balance information associated with the payment instrument. The transaction token corresponds to a tokenized version of the payment instrument. The computer-implemented method further comprises evaluating the reimbursement amount and the balance information to generate a determination. The determination indicates whether fulfillment of the reimbursement request results in a negative balance for the payment instrument. Furthermore, the determination is generated to prevent transmission of impermissible API calls corresponding to reimbursement requests that would not be fulfilled as a result of the negative balance. The computer-implemented method further comprises identifying a reimbursement method for the reimbursement request. The reimbursement method is identified based on the determination. The computer-implemented method further comprises transmitting a reimbursement API call corresponding to the reimbursement request and according to the reimbursement method. The reimbursement API call includes the transaction token. Furthermore, when the reimbursement API call is received at a service corresponding to the reimbursement method, the service uses the transaction token to provide the reimbursement amount according to the reimbursement method.

In some embodiments, processing the invoice includes generating a digitized version of the invoice. The digitized version of the invoice is generated according to a machine-readable format. Processing the invoice further includes dynamically evaluating the digitized version of the invoice to determine the reimbursement amount.

In some embodiments, the determination indicates that fulfillment of the reimbursement request does not result in the negative balance for the payment instrument. Further, when the transaction token is received at the service, the service applies the reimbursement amount to an account associated with the payment instrument.

In some embodiments, the computer-implemented method further comprises transmitting a request to exchange the transaction token for a stored token. The stored token corresponds to a second tokenized version of the payment instrument. Further, the stored token is exchangeable for new transaction tokens associated with the payment instrument. The computer-implemented method further comprises obtaining the stored token. When the stored token is obtained, the transaction token is automatically expired.

In some embodiments, the invoice is associated with a policy corresponding to an insured entity. Further, the computer-implemented method comprises identifying a set of reimbursement methods corresponding to the insured entity. The set of reimbursement methods are identified based on the policy.

In some embodiments, the reimbursement method corresponds to a payment method indicated on the invoice.

In some embodiments, receiving the transaction token further includes retrieving a stored token. The stored token corresponds to the account information associated with the payment instrument. Receiving the transaction token further includes transmitting the stored token such that when the stored token is received at a payment instrument service associated with the payment instrument, the payment instrument service provides the transaction token.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which a claims reimbursement system dynamically processes an invoice and payment instrument information to automatically initiate reimbursement for an existing claim in accordance with at least one embodiment;

FIG. 2 shows an illustrative example of an environment in which a claims reimbursement system dynamically generates a set of reimbursement recommendations for an existing claim and submits a reimbursement request using transaction tokens in accordance with at least one embodiment;

FIG. 3 shows an illustrative example of an environment in which a reimbursement processing sub-system obtains a transaction token corresponding to an existing account for use in a reimbursement request to a payment instrument service in accordance with at least one embodiment;

FIGS. 4A-4B show an illustrative example of an environment in which a reimbursement recommendation algorithm is dynamically trained to generate reimbursement recommendations according to invoice parameters and available reimbursement methods in accordance with at least one embodiment;

FIG. 5 shows an illustrative example of an interface through which a user can initiate submission of a claim for reimbursement in accordance with at least one embodiment;

FIG. 6 shows an illustrative example of an interface through which a user can select one or more conditions associated with the claim being submitted for reimbursement in accordance with at least one embodiment;

FIG. 7 shows an illustrative example of an interface through which a user can provide information corresponding to a provider associated with the claim being submitted for reimbursement in accordance with at least one embodiment;

FIGS. 8A-8C show an illustrative example of an interface through which a user can introduce and select a particular reimbursement method for a claim being submitted for reimbursement in accordance with at least one embodiment;

FIG. 9 shows an illustrative example of an interface through which a user can provide account information corresponding to an existing payment instrument account for use as a reimbursement method for different claims in accordance with at least one embodiment;

FIG. 10 shows an illustrative example of an interface through which a user can provide account information corresponding to an existing account associated with a financial institution for use as a reimbursement method for different claims in accordance with at least one embodiment;

FIG. 11 shows an illustrative example of an interface through which a user can upload an invoice and proof of payment corresponding to a claim to obtain reimbursement for the claim in accordance with at least one embodiment;

FIG. 12 shows an illustrative example of a process for generating and submitting a reimbursement request for a claim using an available reimbursement method in accordance with at least one embodiment;

FIG. 13 shows an illustrative example of a process for obtaining a transaction token corresponding to a selected reimbursement method for submission of a reimbursement request in accordance with at least one embodiment; and

FIG. 14 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework through which one or more machine learning algorithms and programmatic logic are implemented to dynamically, and in real-time, process incoming invoices and corresponding claims as these invoices are received to identify one or more conditions for which treatment was provided. Based on these identified one or more conditions, as well as any known historical data corresponding to the claimant, adjudication of the invoices and corresponding claims may be performed.

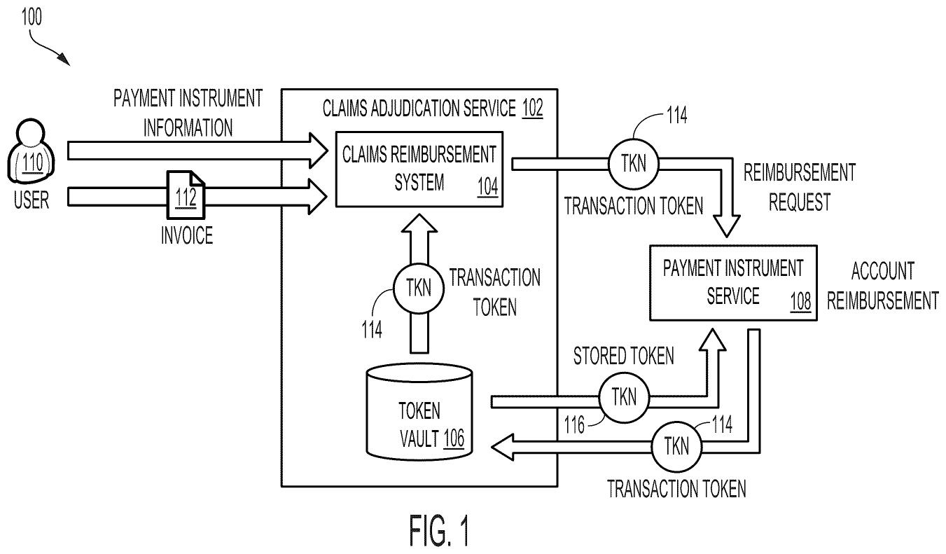

FIG. 1 shows an illustrative example of an environment 100 in which a claims reimbursement system 104 dynamically processes an invoice 112 and payment instrument information to automatically initiate reimbursement for an existing claim in accordance with at least one embodiment. In the environment 100, a user 110 may submit an existing invoice 112 corresponding to treatments and procedures performed for which the user 110 may wish to be reimbursed subject to an existing medical coverage plan and for which the user 110 has provided an upfront payment to the provider of the treatments and procedures performed. For instance, the user 110 may have an existing medical coverage plan associated with a particular coverage provider (e.g., insurance provider, healthcare provider, etc.). The medical coverage plan may include coverage for human treatments and procedures, veterinary treatments and procedures, cosmetic procedures, dental treatments and procedures, therapeutic procedures, and the like. In some instances, the medical coverage plan may require the user 110 to provide upfront payment to a provider (e.g., doctor, veterinarian, etc.) and subsequently submit the corresponding invoice 112 to a claims adjudication service 102 for reimbursement of this upfront payment according to the parameters associated with the user's existing medical coverage plan.

In an embodiment, the invoice 112 is a physical or electronic document that indicates any treatments and/or procedures performed for the benefit of the user 110 or other entity associated with the user 110 (e.g., a dependent, a pet, etc.). For instance, the invoice 112 may indicate any medications provided to the user 110 by the provider at the time of the performance of the treatments and/or procedures. In some instances, the invoice 112 may additionally, or alternatively, indicate any prescriptions provided to the user 110 for medications that are to be applied for the treatment of one or more conditions. The invoice 112, in some examples, may further include additional notes or documentation corresponding to any medication or treatment plans that are to be followed for any underlying conditions. The invoice 112 can further include identifying information associated with the user 110 or other entity for which the invoice 112 was created. For instance, the invoice 112 may provide the user's name, date of birth, address, contact information, and the like. If the treatments and/or procedures were performed for the benefit of an entity other than the user 110, the invoice 112 may indicate the other entity's name, date of birth, address, contact information (if applicable), and the like. In some examples, the invoice 112 may further include identifying information associated with the provider of the treatments and/or procedures performed (e.g., doctor's name, doctor's address, doctor's contact information, doctor's licensing information, etc.).

Invoices, such as invoice 112, may not be uniform in nature. For instance, invoices generated by a particular provider (e.g., doctor, veterinarian, etc.) may differ from invoices generated by other providers. As an illustrative example, a particular provider may implement a set of codes corresponding to different conditions for which treatments and/or procedures may be performed by the particular provider. This set of codes may be included within the particular provider's invoices along with descriptions of the treatments and/or procedures performed. However, this set of codes may be unique to the particular provider, whereby other providers may use different codes or no codes at all when describing the treatments and/or procedures performed for different conditions. This lack of uniformity may make it difficult for the insurance policy provider to identify the conditions for which treatments and/or procedures were performed from received invoices. This difficulty traditionally results in delays in adjudicating claims for reimbursement of upfront expenses incurred by policy holders, as policy providers may be required to perform additional investigations to determine the underlying conditions for which the specified treatments and/or procedures were performed. Further, because of this lack of uniformity, it can be difficult to configure automated systems that may translate different codes into the corresponding conditions. As new codes are generated by different providers, administrators of these automated systems may further need to manually decipher these new codes and, accordingly, update the automated systems to allow the automated systems to translate these new codes. This process can be onerous and can cause significant invoice processing delays, particularly if the automated systems are unable to translate a specified code or if an invoice does not include any codes at all.

The user 110, in some examples, may be a policyholder of an insurance policy for which certain medical treatments and/or procedures may be covered subject to any deductibles defined in the policy. In some instances, the insurance policy may not be applicable for pre-existing conditions that may have been known to the user 110 and to the policy provider at the time of the issuance of the insurance policy. For example, the insurance policy provider may automatically deny any claims for reimbursement related to treatments and/or procedures associated with conditions that pre-dated the issuance of the insurance policy. In some instances, the insurance policy may provide reduced coverage for pre-existing conditions, whereby users may be provided with limited or reduced reimbursement for treatments and/or procedures associated with these pre-existing conditions.

In an embodiment, the claims adjudication service 102 is associated with the insurance policy provider. For instance, the claims adjudication service 102 may be implemented by the insurance policy provider to dynamically, and automatically, process incoming claims for reimbursement in real-time subject to applicable policies and corresponding terms. The claims adjudication service 102, as such, may have access to other systems implemented by the insurance policy provider (e.g., user/policy holder databases, payment systems, etc.). In some instances, the claims adjudication service 102 may be implemented by a third-party, whereby the claims adjudication service 102 may be required to access insurance policy provider systems through a communications network (such as the Internet) or through one or more application programming interfaces (APIs) exposed by the insurance policy provider to the claims adjudication service 102 according to the relationship between the insurance policy provider and the provider of the claims adjudication service 102 (such as through a set of credentials, cryptographic keys, etc.). The claims adjudication service 102 may be implemented on a set of computer systems or other systems (e.g., servers, virtual machine instances, etc.). In some instances, the claims adjudication service 102 may be implemented as a set of applications or other executable processes executed on one or more computing systems associated with the insurance policy provider or third-party that implements the claims adjudication service 102.

In an embodiment, the user 110 submits an invoice 112 to a claims reimbursement system 104 implemented by a claims adjudication service 102 to request reimbursement of upfront expenses incurred by the user 110 for treatments and/or procedures performed. The claims reimbursement system 104 may be implemented on a computer system or other system (e.g., server, virtual machine instance, etc.) associated with the claims adjudication service 102. Alternatively, the claims reimbursement system 104 may be implemented as an application or other executable process executed on one or more computer systems associated with the claims adjudication service 102. The request for reimbursement may include the invoice 112 and payment instrument information corresponding to a selected reimbursement method for the upfront expenses paid by the user 110 and indicated on the invoice 112. For instance, when submitting an invoice 112 for reimbursement, the claims adjudication service 102 may prompt the user 110 to provide identifying information associated with the user 110 or other entity associated with the corresponding insurance policy. For instance, the user 110 may be prompted to provide an identifier corresponding to the insurance policy (e.g., policy number, etc.), the name of the policy holder (e.g., name of the user 110, name of the entity insured, etc.), and the like. It should be noted that, in some instances, the user 110 may not be required to provide additional information along with the invoice 112, as the invoice 112 may include sufficient identifying information associated with the user 110 and/or the entity insured to identify a corresponding insurance policy.

The claims adjudication service 102, through the claims reimbursement system 104, may further prompt the user 110 to indicate their preferred reimbursement method for the invoice 112. In an embodiment, if the user 110 has an existing account with the claims adjudication service 102 or has otherwise previously submitted a reimbursement request to the claims adjudication service 102, the claims reimbursement system 104 may automatically access this existing account or other record corresponding to these previous reimbursement requests to identify any available reimbursement methods associated with the user 110. These available reimbursement methods may correspond to existing payment instrument accounts, existing checking accounts associated with one or more banks or other financial institutions, existing savings accounts associated with one or more banks or other financial institutions, and the like. The claims reimbursement system 104 may provide these available reimbursement methods to the user 110 (such as through a graphical user interface (GUI)) to allow the user 110 to select a preferred reimbursement method for the invoice 112.

In an embodiment, the claims reimbursement system 104 can further prompt the user 110 to select a new reimbursement method for the invoice 112. For instance, if the user 110 does not have an existing account with the claims adjudication service 102 or has otherwise never submitted a reimbursement request to the claims adjudication service 102, the claims reimbursement system 104 may automatically prompt the user 110 to provide account information corresponding to a particular reimbursement method for the invoice 112. As an illustrative example, the claims reimbursement system 104 may prompt the user 110 to provide account information corresponding to a payment instrument to which a reimbursement associated with the invoice 112 may be submitted. This payment instrument account may be associated with a particular payment instrument service 108 that provides payment instruments to users, such as user 110, for use in paying any upfront expenses associated with treatments and procedures performed and subject to an existing medical coverage plan. Thus, in some instances, the payment instrument service 108 may be associated with the claims adjudication service 102. In some examples, the payment instrument service 108 may be a third-party entity that is not associated with the claims adjudication service 102 but may otherwise provide payment instruments that may be used for any purpose. However, in these examples, the payment instrument service 108 may allow for reimbursements to be submitted to existing payment instrument accounts, as described in greater detail herein.

In an embodiment, in response to receiving an invoice 112 from the user 110, the claims reimbursement system 104 automatically processes the invoice 112 to generate a digitized version of the invoice 112 and to identify any corresponding parameters that may be used to identify the reimbursement amount for the claim being submitted and the payment method used for the upfront payment indicated in the invoice 112. In an embodiment, the claims reimbursement system 104 implements an optical character recognition (OCR) process to convert received invoices into digitized versions of these invoices. The OCR process executed by the claims reimbursement system 104 may automatically scan a received invoice, such as invoice 112, to automatically and in real-time identify any text included in the invoice and, accordingly, generate digitized version of the invoice that is machine-readable (e.g., a system can discern textual elements from the digitized version of the invoice). As an illustrative example, if a user 110 submits a physical copy of the invoice 112 to the claims reimbursement system 104, the claims reimbursement system 104 may perform an initial scan of the invoice 112 to generate an electronic version of the invoice 112. However, this electronic version of the invoice 112 may initially only include a digital image of the invoice 112 that is not searchable or editable. Accordingly, the claims reimbursement system 104 may execute an OCR process on the electronic version of the invoice 112 to identify the text included in the electronic version of the invoice 112 and to generate the searchable digitized invoice. Similarly, if the user 110 submits an electronic version of the invoice 112 themselves, the claims reimbursement system 104 may execute the aforementioned OCR process on the electronic version of the invoice 112 submitted by the user 110 to identify the text included in the electronic version of the invoice 112 and to generate a searchable, digitized version of the invoice 112.

In an embodiment, the claims reimbursement system 104 implements a machine learning algorithm or artificial intelligence to process the received invoice 112 to extract any elements from the invoice 112 that may be useful in identifying upfront payments that were made for any indicated treatments and/or procedures. For example, the machine learning algorithm or artificial intelligence implemented by the claims reimbursement system 104 can include one or more natural language processing (NLP) algorithms that may automatically process a digitized invoice in real-time as these digitized invoices are generated from received invoices to identify any relevant terms corresponding to upfront payments made for indicated treatments and/or procedures. For instance, the one or more NLP algorithms may be dynamically trained to extract any terms corresponding to payment instruments or other payment methods used for an indicated balance from the invoice 112.

As used herein, NLP is a mechanism whereby computational systems such as those described herein may be used to process and analyze language (from text sources) that is natural (i.e., unstructured). In such systems, the result of the analysis may enable the NLP algorithms to generate insights (i.e., information) about the contents of the source communications and, by extension, about other communications that are in the same language. In such systems, the result of the analysis may enable the NLP algorithms to categorize and/or provide metadata about the source communications and/or about other communications. Being able to both understand and categorize natural language enables a system (e.g., the claims reimbursement system 104, etc.) to generate better and/or more accurate insights from natural language and may provide a basis for a system that can receive natural language, understand it, and respond in a reasonable manner. As the NLP algorithms process and analyze a larger set of natural language sources (e.g., digitized invoices, etc.), the quality of the understanding and interaction may improve. Examples of NLP algorithms include, but are not limited to, rule-based NLP (also referred to as “symbolic” NLP and based on sets of applied rules), statistical NLP (generally implemented with unsupervised and/or semi-supervised statistical analyses of unstructured data), and Neural NLP (based on representation learning and deep-learning artificial intelligence techniques). As may be contemplated, when analyzing text sources for NLP, systems can directly input the text into the analysis system.

In an embodiment, once the claims reimbursement system 104 has determined, from the digitized version of the invoice 112, the payment amount being requested by the user 110, the claims reimbursement system 104 can determine whether the payment amount may be reimbursed to the user 110 through the selected reimbursement method. For example, if the user 110 has selected, as their reimbursement method, a particular payment instrument associated with the payment instrument service 108, the claims reimbursement system 104 may transmit an API call to the payment instrument service 108 to determine the existing balance (if any) associated with the particular payment instrument. This API call may include any available account information associated with the particular payment instrument that may be used by the payment instrument service 108 to identify the target payment instrument account and return the existing balance (if any) associated with this payment instrument.

In some instances, the API call to the payment instrument service 108 may include an access token or other authentication information that may be used by the payment instrument service 108 to authenticate the claims reimbursement system 104. This access token or other authentication information may be provided to the claims reimbursement system 104 through one or more available authentication processes (e.g., shared secrets, symmetric key cryptography, asymmetric key cryptography, etc.). Accordingly, in response to the API call from the claims reimbursement system 104, the payment instrument service 108 may authenticate the API call through evaluation of the provided access token or other authentication information.

In response to the API call from the claims reimbursement system 104, the payment instrument service 108 may return the existing balance (if any) for the particular payment instrument selected by the user 110. Additionally, in some instances, the payment instrument service 108 may further return a transaction token 114 that may be used for any transactions between the claims reimbursement system 104 and the payment instrument service 108 for the particular payment instrument. The transaction token 114 may include a tokenized version of the particular payment instrument associated with the user 110. To generate the transaction token 114 corresponding to the particular payment instrument, the payment instrument service 108 may dynamically generate, in real-time, a unique payment instrument number that may be associated with the particular payment instrument selected for the present reimbursement. The unique payment instrument number may include one or more characteristics that may be used to associate the transaction token 114 with the payment instrument service 108. For instance, a certain number of digits associated with the unique payment instrument number may be fixed and may correspond to the payment instrument service 108. For instance, the unique payment instrument number may include an issuer identification number (IIN) or bank identification number (BIN), which may uniquely identify the payment instrument service 108. The remaining digits corresponding to the unique payment instrument number may be randomized and the complete unique payment instrument number may be automatically associated with the payment instrument selected by the user 110.

In addition to generating a unique payment instrument number for the transaction token 114, the payment instrument service 108 may assign an expiration date and Card Verification Value (CVV) or other security code for the transaction token 114. The combination of the unique payment instrument number, expiration date, and CVV or other security code may provide a unique combination of elements used to define a new transaction token 114 that may be uniquely associated with the pairing of the actual payment instrument selected by the user and the reimbursement for which the unique transaction token 114 is being generated. The transaction token 114, in an embodiment, is configured for a single use, whereby if a reimbursement is completed using the transaction token 114, the transaction token 114 is automatically expired by the payment instrument service 108. In some instances, the expiration date for the transaction token 114 may be short (e.g., one hour, two hours, one day, etc.) such that the transaction token 114 may be automatically expired if not used within a short window of time for the reimbursement.

In an embodiment, prior to submitting an API call to the payment instrument service 108 to determine the existing balance associated with a selected payment instrument, the claims reimbursement system 104 queries a token vault 106 implemented by the claims adjudication service 102 to determine whether an existing stored token 116 corresponding to the selected payment instrument is stored within the token vault 106. The stored token 116 for a particular payment instrument may be similar to the transaction token 114 described above. For instance, the stored token 116 maintained in the token vault 106 may include a tokenized version of the particular payment instrument associated with the user 110. However, the stored token 116 may have a longer expiration date (e.g., one year, etc.), which may allow for continued retrieval of transaction tokens associated with the particular payment instrument without having to repeatedly provide payment instrument account information through the API call to the payment instrument service 108. This may reduce the payload size of any API calls to the payment instrument service 108, thereby reducing the required network bandwidth for obtaining transaction tokens. Further, by using a stored token 116, the amount of processing performed by the systems of the payment instrument service 108 is reduced, as these systems may not need to perform continued authentication of the claims reimbursement system 104 and evaluate payment instrument account information for generation of transaction tokens.

The stored token 116, in an embodiment, is provided by the payment instrument service 108 in exchange for a previously generated transaction token 114 associated with the selected payment instrument. For instance, if the token vault 106 does not maintain a stored token 116 for a particular payment instrument that is associated with a current claim reimbursement, the claims reimbursement system 104 may transmit a request to the payment instrument service 108 to obtain a stored token 116 corresponding to the particular payment instrument. This request may be transmitted to the payment instrument service 108 in response to an indication from the payment instrument service 108 that the reimbursement to the particular payment instrument was completed successfully. Once the claims reimbursement system 104 has obtained the stored token 116 from the payment instrument service 108, the claims reimbursement system 104 may store the stored token 116 in the token vault 106. For instance, the claims reimbursement system 104 may define a new entry corresponding to the payment instrument selected by the user 110 in the token vault 106. This new entry may include the payment instrument account information provided by the user 110. Once the claims reimbursement system 104 defines a new entry for the payment instrument or identifies an existing entry corresponding to the payment instrument, the claims reimbursement system 104 may associate the newly obtained stored token 116 with this entry within the token vault 106. This may allow the claims reimbursement system 104 to query the token vault 106 for the stored token 116 if the user 110 later submits a new reimbursement request that specifies the corresponding payment instrument as the preferred reimbursement method for the underlying claim.

In an embodiment, if the token vault 106 maintains a valid stored token 116 corresponding to the selected payment instrument, the claims reimbursement system 104, through the token vault 106, may submit a request to the payment instrument service 108 to obtain a transaction token 114 for the reimbursement request. The request may include the stored token 116 previously provided by the payment instrument service 108. In response to the request, the payment instrument service 108 may evaluate the stored token 116 to determine whether the stored token 116 is valid and is associated with an existing payment instrument account maintained by the payment instrument service 108. If the payment instrument service 108 determines that the stored token 116 provided in the request is valid, the payment instrument service 108 may generate and issue a transaction token 114 that may be used for the present reimbursement request. This transaction token 114 may be stored in the token vault 106 in association with the entry corresponding to the payment instrument. Accordingly, the claims reimbursement system 104 may retrieve the transaction token 114 from the token vault 106 for use in the reimbursement request to the payment instrument service 108. If the claims reimbursement system 104 determines that the stored token 116 is expired or that the token vault 106 does not maintain a stored token 116 for the payment instrument selected by the user 110 for the reimbursement request, the claims reimbursement system 104 may transmit the aforementioned API call (including the access token and the payment instrument account information supplied by the user 110) to the payment instrument service 108 to obtain the transaction token 114.

As noted above, the claims reimbursement system 104 may obtain, from the payment instrument service 108, balance information corresponding to the payment instrument selected by the user 110 for the reimbursement request. In an embodiment, the claims reimbursement system 104 evaluates the obtained balance information and the reimbursement amount requested by the user 110 (e.g., the amount paid as indicated on the invoice 112, etc.) to determine whether application of this reimbursement amount to the account associated with the payment instrument would result in a negative balance for the payment instrument (e.g., the reimbursement would result in an overpayment of the outstanding balance (if any) associated with the payment instrument). If the claims reimbursement system 104 determines that the requested reimbursement would result in a negative balance for the payment instrument, the claims reimbursement system 104 may generate one or more alternative reimbursement method recommendations that may be presented to the user 110. Negative balances may represent potential liabilities for the payment instrument service 108, whereby the payment instrument service 108 may be required to hold this negative balance in abeyance until the user 110 uses their payment instrument for other transactions and the negative balance can be applied to these transactions. By preventing application of a reimbursement amount that would result in a negative balance, the claims reimbursement system 104 reduces this additional burden on the payment instrument service 108 and reduces the accounting and processing required by the payment instrument service 108 for maintaining and implementing negative balances. Thus, unlike traditional claims adjudication systems that are agnostic to balances associated with different payment instrument accounts when providing a reimbursement, the claims reimbursement system 104 reduces the computational requirements of the payment instrument service 108 for handling negative balances.

In an embodiment, the claims reimbursement system 104 implements a machine learning algorithm or artificial intelligence that is dynamically trained to generate reimbursement method recommendations for different reimbursement requests in real-time and as these reimbursement requests are received. The machine learning algorithm or artificial intelligence implemented by the claims reimbursement system 104 may be dynamically trained in real-time using supervised learning techniques. For example, a dataset of sample invoices (e.g., historical invoices corresponding to different users, hypothetical invoices corresponding to hypothetical users, etc.), known available reimbursement methods for the sample invoices, and selections made from these known available reimbursement methods can be selected for training of the machine learning algorithm or artificial intelligence. In some embodiments, data corresponding to the sample users may include any existing balances associated with any of the available reimbursement methods corresponding to the sample users. The machine learning algorithm or artificial intelligence may be evaluated to determine, based on the input sample invoices and known available reimbursement methods supplied to the machine learning algorithm or artificial intelligence, whether the machine learning algorithm or artificial intelligence is generating desirable reimbursement method recommendations that comport with any applicable constraints (e.g., negative balance constraints, etc.). For instance, if the machine learning algorithm or artificial intelligence generates a reimbursement method recommendation corresponding to an account that would have a negative balance if the reimbursement is applied to the account, the machine learning algorithm or artificial intelligence may be dynamically retrained to reduce the likelihood of the machine learning algorithm or artificial intelligence generating a similar recommendation for similar invoices and/or available reimbursement methods. Alternatively, if the machine learning algorithm or artificial intelligence generates a reimbursement method recommendation that does not violate any negative balance constraints or other applicable constraints on what may be offered to a user for reimbursement of the payment amount, the machine learning algorithm or artificial intelligence may be dynamically reinforced such that similar recommendations may be provided for similar invoices and/or available reimbursement methods. Thus, the machine learning algorithm or artificial intelligence implemented by the claims reimbursement system 104 may reduce the processing requirements of the claims adjudication service 102. For example, the machine learning algorithm or artificial intelligence may prevent duplicative processing due to errors caused by selection of impermissible reimbursement methods as these impermissible reimbursement methods may not be recommended or otherwise not presented to the user 110. This may ensure that any reimbursement requests are more likely to be processed without any errors or other issues that may cause delays in account reimbursement and duplicative interactions with the user 110.

The machine learning algorithm or artificial intelligence may further be dynamically trained in real-time based on reimbursement method selections made by the sample users. For instance, an administrator of the claims adjudication service 102 may review a sample reimbursement request (including a sample invoice), data corresponding to the reimbursement methods available to the sample user associated with the sample reimbursement request, and the reimbursement method recommendations generated by the machine learning algorithm or artificial intelligence to determine whether the machine learning algorithm or artificial intelligence has provided recommendations that comport with the sample reimbursement request and the available reimbursement methods (subject to any applicable constraints). Annotations made by this administrator to the reimbursement method recommendations made by the machine learning algorithm or artificial intelligence may be supplied to further train the machine learning algorithm or artificial intelligence. As another illustrative example, as different users make selections of reimbursement methods for different reimbursement requests, the claims adjudication service 102 may use these actual selections and corresponding reimbursement requests (including corresponding invoices and available reimbursement methods) as feedback that may be used to dynamically update the machine learning algorithm or artificial intelligence. Thus, the machine learning algorithm or artificially intelligence may be continuously updated, in real-time, as users select different reimbursement methods for corresponding reimbursement requests.

In an embodiment, the machine learning algorithm or artificial intelligence is implemented to provide reimbursement method recommendations in response to received reimbursement requests regardless of whether the user 110 initially selects an impermissible reimbursement method (e.g., a payment instrument account that would have a negative balance if the reimbursement was made to this account, etc.) or not. For instance, when the user 110 submits a reimbursement request to the claims reimbursement system 104, the claims reimbursement system 104 may automatically process the reimbursement request (including any provided payment instrument information and the invoice 112) and any existing information about the user 110 (e.g., policy information, known account information for different accounts associated with the claims adjudication service 102, etc.) through the machine learning algorithm or artificial intelligence to generate one or more reimbursement method recommendations that may be presented to the user 110. As another illustrative example, the claims reimbursement system 104 may process the reimbursement request and any existing information about the user 110 through the machine learning algorithm or artificial intelligence in the event that an initially selected reimbursement method is not available to the user 110 (e.g., an account selected by the user 110 would have a negative balance if the reimbursement is made to the account, etc.).

Returning to the illustrative example above, where the claims reimbursement system 104 has obtained balance information corresponding to a payment instrument account selected by the user 110 for reimbursement of the upfront payment indicated on the invoice 112, if the claims reimbursement system 104 determines that the reimbursement may be made to the payment instrument account (e.g., the reimbursement would not result in a negative balance), the claims reimbursement system 104 may submit an API call to the payment instrument service 108 to request reimbursement of the upfront payment to the user's payment instrument account. This may prevent transmission of impermissible API calls corresponding to reimbursement requests that, if fulfilled, would result in negative balances. Through this filtering of reimbursement requests, the claims reimbursement system 104 may limit and thereby reduce the processing performed by the payment instrument service 108 related to received reimbursement requests. The API call to the payment instrument service 108 may include the transaction token 114 and information corresponding to the reimbursement request submitted by the user 110. This information may indicate the amount that is to be reimbursed to the user's payment instrument account, the reimbursement payment source (e.g., an account associated with the claims adjudication service 102, etc.), the claim number and/or other claim details as indicated in the invoice 112, and the like.

In response to the reimbursement API call submitted by the claims reimbursement system 104, the payment instrument service 108 may process the received transaction token 114 to identify the payment instrument account to which the reimbursement is to be made. For instance, the payment instrument service 108 may detokenize the transaction token 114 by determining whether the tokenized payment instrument included in the transaction token 114 corresponds to an active payment instrument account maintained by the payment instrument service 108. If so, the payment instrument service 108 may retrieve the account details corresponding to this payment instrument account to process the reimbursement request. However, if the payment instrument service 108 determines that the transaction token 114 is invalid (e.g., the transaction token 114 has expired, the transaction token 114 is not associated with an active payment instrument account, etc.), the payment instrument service 108 may reject the reimbursement request. Accordingly, the claims reimbursement system 104 may generate one or more new reimbursement method recommendations that may be provided to the user 110, as described above.

If the transaction token 114 is valid, the payment instrument service 108 may schedule the reimbursement payment to the payment instrument account, such as through an automated clearing house (ACH) process whereby the reimbursement amount is obtained from the indicated reimbursement payment source and applied to the payment instrument account maintained by the payment instrument service 108. The payment instrument service 108 may post the reimbursement to the user's payment instrument account such that, in a statement provided to the user 110 corresponding to this payment instrument, the reimbursement may be indicated. The reimbursement notification, as indicated in the statement, may include the reimbursement amount, the source of the reimbursement (e.g., the claims adjudication service 102), and other information that may uniquely associate the reimbursement to the submitted claim for which the reimbursement was requested.

In an embodiment, if the token vault 106 does not maintain a stored token 116 corresponding to the payment instrument selected by the user 110 for the reimbursement, the claims reimbursement system 104 links the user's claims adjudication service account with the payment instrument account by exchanging the transaction token 114 for a new stored token 116. For instance, in response to receiving a notification from the payment instrument service 108 that the reimbursement request was processed successfully, the claims reimbursement system 104 may transmit an API call to the payment instrument service 108 to exchange the transaction token 114 for a new stored token 116. This API call may include the transaction token 114 and identifying information corresponding to the claims adjudication service 102 that may be used to authenticate the request. If the payment instrument service 108 successfully authenticates this API call from the claims reimbursement system 104, the payment instrument service 108 may dynamically generate a stored token 116 that may be used to obtain future transaction tokens 114 for reimbursement requests associated with the corresponding payment instrument. This new stored token 116 may be stored in the token vault 106 in association with the user's payment instrument account and the user's claims adjudication service 102 account, as described above.

In an embodiment, as reimbursement method selections are made by users associated with the claims adjudication service 102 and corresponding reimbursement requests are processed according to these selections, the claims reimbursement system 104 can, in real-time, update the machine learning algorithm or artificial intelligence implemented to automatically generate reimbursement method recommendations based on received invoices and corresponding user accounts to increase the accuracy of the machine learning algorithm or artificial intelligence. For example, if the claims reimbursement system 104 provided, using the machine learning algorithm or artificial intelligence, a particular reimbursement method recommendation for a particular user 110 and corresponding invoice 112 but the payment instrument service 108 rejects the reimbursement request because the reimbursement would result in a negative balance for the corresponding payment instrument account, the claims reimbursement system 104 may use this feedback to dynamically update the machine learning algorithm or artificial intelligence such that, for similar users and invoices, the likelihood of similar recommendations being provided is reduced. As another example, if the user 110 selects a reimbursement method that was not recommended by the claims reimbursement system 104, the claims reimbursement system 104 may update the machine learning algorithm or artificial intelligence such that, for similar users and invoices, the likelihood of the machine learning algorithm or artificial intelligence recommending similar reimbursement methods as that selected by the user 110 is increased. Thus, as the machine learning algorithm or artificial intelligence is dynamically updated based on feedback (e.g., reimbursement method selections, responses from the payment instrument service 108 to submitted reimbursement requests, etc.), the number of unnecessary interactions between the user 110 and the claims adjudication service 102 may be reduced. For instance, the retraining of the machine learning algorithm or artificial intelligence may result in the generation and presentation of relevant and appealing reimbursement recommendations that are less likely to be rejected by the payment instrument service 108 and by the user 110, resulting in fewer recommendation iterations for a singular reimbursement request.

It should be noted that the machine learning algorithm or artificial intelligence implemented by the claims reimbursement system 104 may be dynamically, and continuously, updated in real-time as reimbursement requests (including corresponding invoices) associated with different users and different medical events are received and as the claims associated with these reimbursement requests are processed (e.g., reimbursements are made to selected accounts, reimbursement requests are rejected, etc.). Further, the machine learning algorithm or artificial intelligence may be dynamically, and continuously, updated in real-time as feedback is received corresponding to the reimbursement method recommendations generated in response to reimbursement requests from different users and corresponding to different invoices. As noted above, if the claims reimbursement system 104 provides a reimbursement method recommendation that is not selected by a user 110 and the user 110 is successfully able to obtain a reimbursement according to their preferred reimbursement method, the claims reimbursement system 104 may use the user's selection of this alternative and preferred reimbursement method as feedback to retrain the machine learning algorithm or artificial intelligence. Similarly, if the user selects a recommended reimbursement method but their reimbursement request is later rejected by a payment instrument service or other service associated with the recommended reimbursement method, the claims reimbursement system 104 may use this rejection as feedback that may be used to retrain the machine learning algorithm or artificial intelligence to decrease the likelihood of similar reimbursement methods being recommended for similarly situated users and corresponding invoices. Thus, as reimbursement requests and invoices are continuously received and processed for myriad users, the claims reimbursement system 104 may dynamically, and in real-time, continuously update the machine learning algorithm or artificial intelligence to increase its accuracy in automatically generating reimbursement method recommendations associated with these reimbursement requests. This increase in accuracy may reduce the number interactions and, thus, the amount of processing required by the claims reimbursement system 104 to successfully process a reimbursement request from different users.

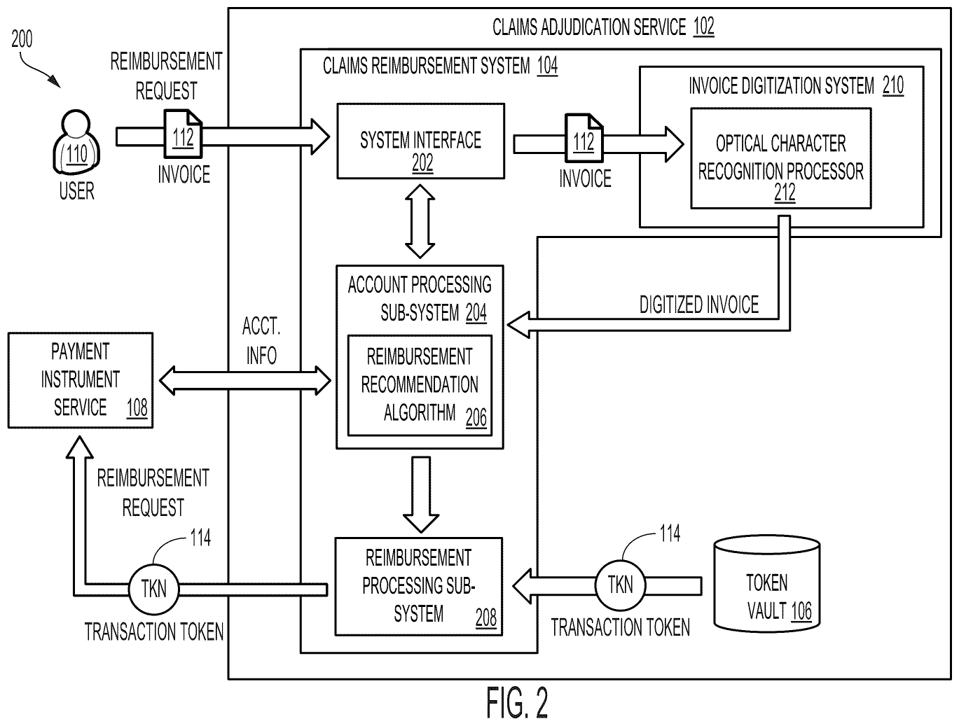

FIG. 2 shows an illustrative example of an environment 200 in which a claims reimbursement system 104 dynamically generates a set of reimbursement recommendations for an existing claim and submits a reimbursement request using transaction tokens 114 in accordance with at least one embodiment. In the environment 200, the claims adjudication service 102, through a system interface 202 implemented by the claims reimbursement system 104, may receive a reimbursement request from a user 110. The reimbursement request may include an invoice 112 corresponding to treatments and procedures performed for which the user 110 may wish to be reimbursed subject to an existing medical coverage plan and for which the user 110 has provided an upfront payment to the provider of the treatments and procedures performed. In some instances, through the system interface 202, the user 110 may provide information corresponding to one or more payment instrument accounts or other accounts (e.g., bank or other financial institution accounts, etc.) that the user 110 would like to associate with their claims adjudication service account. The system interface 202 implemented by the claims reimbursement system 104 may include one or more GUIs through which the user 110 may submit their reimbursement request, including one or more invoices 112 for which the user 110 would like to be reimbursed for any upfront expenses paid by the user 110 and indicated on these one or more invoices 112. The system interface 202 may be accessed by the user 110 through a website or other web portal implemented by the claims adjudication service 102 and/or through an application provided by the claims adjudication service 102 to users.

If the user 110 uploads an invoice 112 to the system interface 202 as part of their reimbursement request, the invoice 112 may be automatically provided to an invoice digitization system 210 for digitization of the invoice 112 and to identify any terms corresponding to payment instruments or other payment methods used for an indicated balance from the invoice 112. In an embodiment, the invoice digitization system 210 implements an optical character recognition (OCR) processor 212 that may be configured to generate the digitized version of the invoice 112. The OCR processor 212 may be implemented on a computer system or other system (e.g., server, virtual machine instance, etc.) associated with the invoice digitization system 210. Alternatively, the OCR processor 212 may be implemented as an application or other executable process executed on one or more computer systems associated with the invoice digitization system 210.

The OCR processor 212 may automatically scan invoice 112 to automatically, and in real-time, identify any text included in the invoice 112 and to generate a digitized version of the invoice 112. The digitization of the invoice 112 may be performed by the OCR processor 212 using an OCR process, whereby the invoice 112 is digitized into a machine-readable format to allow for discernment of textual elements from the invoice 112. As noted above, a user 110 may submit a physical or electronic version of the invoice 112 to request reimbursement of upfront expenses incurred by the user 110 for the line items in the invoice 112. The OCR processor 212 may perform the aforementioned OCR process on the physical or electronic version of the invoice 112 to identify the text included in the invoice 112 and to generate the searchable, digitized version of the invoice 112.

In an embodiment, the OCR processor 212 further includes one or more NLP algorithms that are dynamically trained in real-time to process digitized versions of received invoices to extract elements useful in identifying any relevant terms corresponding to upfront payments made for indicated treatments and/or procedures. For instance, these one or more NLP algorithms may be dynamically trained to extract any terms corresponding to the payment methods utilized to provide upfront payments for the indicated treatments and/or procedures. Further, these one or more NLP algorithms may be dynamically trained to extract any terms corresponding to any payment amounts corresponding to these upfront payments and to each of the payment methods utilized. The OCR processor 212 may store the digitized version of the invoice 112 within an entry corresponding to the user 110 that submitted the invoice 112 in a user accounts datastore. Further, the OCR processor 212 may transmit the digitized version of the invoice 112 and the extracted terms to an account processing sub-system 204 implemented by the claims reimbursement system 104.

In an embodiment, the account processing sub-system 204 processes the digitized version of the invoice 112 and the extracted terms through a data structure to determine whether these extracted terms correspond to one or more known payment methods. This data structure may include a mapping of particular terms or term combinations to known payment methods (e.g., different payment instruments, different account types, etc.). For example, a combination of terms may collectively correspond to a particular payment instrument service associated with a payment instrument used to provide an upfront payment, as indicated on the digitized invoice 112. The data structure may be defined through historical analysis of past upfront payments and corresponding payment methods indicated in past invoices for different users, whereby particular terms and phrases may be mapped to different payment methods and corresponding providers (e.g., payment instrument services, financial institutions, etc.).

In an embodiment, the account processing sub-system 204 processes the digitized invoice 112 and the reimbursement request from the user 110 to determine whether the user 110 has provided an indication of a preferred reimbursement method for the corresponding claim. For instance, when the user 110 accesses the system interface 202 to submit their reimbursement request, the account processing sub-system 204 may automatically determine whether the user 110 has previously defined and associated one or more reimbursement methods with an existing claims adjudication service account. If the user 110 has previously associated one or more reimbursement methods with their claims adjudication service account, the account processing sub-system 204, through the system interface 202, may present these one or more reimbursement methods to the user 110. In some instances, if the user 110 has not associated a reimbursement method with their existing claims adjudication service account or is a new user of the claims adjudication service 102, the account processing sub-system 204, through the system interface 202, may prompt the user 110 to provide account information corresponding to a preferred reimbursement method (e.g., a payment instrument, a checking account, a savings account, etc.) that may be associated with their claims adjudication service account. Thus, through the system interface 202, the account processing sub-system 204 may identify any initial reimbursement method selections made by the user 110 in their reimbursement request.

In addition to reviewing the reimbursement request to determine whether the user 110 has selected a preferred reimbursement method for their request, the account processing sub-system 204 may evaluate the digitized invoice 112, as described above, to identify the one or more payment methods used for the upfront payments indicated in the digitized invoice 112. The account processing sub-system 204 may evaluate the user's claims adjudication service account to determine whether these identified one or more payment methods correspond to any previously defined reimbursement methods provided by the user 110 to the claims adjudication service 102. If the one or more payment methods correspond to any previously defined reimbursement methods associated with the user 110, the account processing sub-system 204 may query the user's claims adjudication service account to retrieve any additional account information associated with these one or more payment methods. However, if additional account information is required in order to feasibly process the reimbursement request according to any of these payment methods, the account processing sub-system 204, through the system interface 202, may prompt the user 110 to provide this additional account information.

In an embodiment, the account processing sub-system 204 uses any provided account information corresponding to the selected reimbursement method and to any other reimbursement methods associated with the user's claims adjudication service account to determine whether these reimbursement methods may be used for the reimbursement request. As an illustrative example, if the user 110 provides account information corresponding to a payment instrument issued by a payment instrument service 108, the account processing sub-system 204 may call an account search API associated with the payment instrument service 108 to request additional account information associated with this payment instrument. The API call to the payment instrument service 108 may include the account information provided by the user 110 in their reimbursement request and/or obtained from the user's claims adjudication service account. Further, the API call may include an access token or other authentication information that may be used by the payment instrument service 108 to authenticate the account processing sub-system 204.

In response to the request from the account processing sub-system 204, the payment instrument service 108 may determine whether the provided account information corresponds to an existing payment instrument account maintained by the payment instrument service 108. For instance, if the account information provided by the account processing sub-system 204 includes a primary account number (PAN) associated with a payment instrument, the payment instrument service 108 may use the provided PAN to determine whether this PAN corresponds to an existing and active payment instrument account. If so, the payment instrument service 108 may return, in response to the API call from the account processing sub-system 204, any account information associated with the payment instrument that may be used to determine whether the reimbursement may be issued to the payment instrument account. For instance, the payment instrument service 108 may return the current balance for the payment instrument, the open-to-buy (OTB) response (e.g., determination as to whether the payment instrument is valid and active for use), and the like.

Using the provided account information from the payment instrument service 108, the account processing sub-system 204 may determine whether the reimbursement may be issued to the account indicated by the user 110 in their reimbursement request. For instance, the account processing sub-system 204 may compare the reimbursement amount (as identified through evaluation of the digitized invoice 112 and the associated terms extracted by the OCR processor 212) to the existing balance associated with the selected account to determine whether issuance of a reimbursement to the account would result in the account having a negative balance. Further, the account processing sub-system 204 may determine, based on the provided OTB response, whether the selected account is valid and active, such that the requested reimbursement may be credited to the selected account. In some instances, if the selected account is invalid, inactive, or the reimbursement would result in the selected account having a negative balance, the account processing sub-system 204 may reject this selected account and, through the system interface 202, prompt the user 110 to select an alternative reimbursement method for their reimbursement request. By rejecting the selected account under these conditions, the account processing sub-system 204 may eliminate any reimbursement requests that may be rejected by the payment instrument service 108 and, thereby, reduce the processing requirements of the claim reimbursement system 104. This may result in increased processing efficiencies for the claims reimbursement system 104 as any processes and communications related to rejected reimbursement requests may be prevented.

In an embodiment, the account processing sub-system 204 implements a reimbursement recommendation algorithm 206 that is dynamically trained, in real-time, to generate different reimbursement method recommendations in response to different reimbursement requests. The reimbursement recommendation algorithm 206 may be a machine learning algorithm or artificial algorithm that is dynamically trained, in real-time, using supervised learning techniques. For instance, the reimbursement recommendation algorithm 206 may be initially trained using a selection from a dataset of sample invoices (e.g., historical invoices corresponding to different users, hypothetical invoices corresponding to hypothetical users, etc.), known available reimbursement methods for the sample invoices, and selections made from these known available reimbursement methods. The reimbursement recommendation algorithm 206, based on the output generated by the reimbursement recommendation algorithm 206 using the selection from the aforementioned dataset, may be evaluated to determine whether the reimbursement recommendation algorithm 206 is generating desirable reimbursement method recommendations that comport with any applicable constraints (e.g., negative balance constraints, OTB response constraints, etc.). Based on this evaluation, the reimbursement recommendation algorithm 206 may be retrained to improve the accuracy of the reimbursement recommendation algorithm 206 in generating accurate and valid reimbursement method recommendations.

The reimbursement recommendation algorithm 206 may further be dynamically trained in real-time based on reimbursement method selections made by the sample users. For instance, an administrator of the claims adjudication service 102 may review a sample reimbursement request (including a sample invoice), data corresponding to the reimbursement methods available to the sample user associated with the sample reimbursement request, and the reimbursement method recommendations generated by the reimbursement recommendation algorithm 206 to determine whether the reimbursement recommendation algorithm 206 has provided recommendations that comport with the sample reimbursement request and the available reimbursement methods. Annotations made by this administrator to the reimbursement method recommendations made by the reimbursement recommendation algorithm 206 may be added to the dataset to further train the machine learning algorithm or artificial intelligence. As another illustrative example, as different users make selections of reimbursement methods for different reimbursement requests, the account processing sub-system 204 may use these actual selections and corresponding reimbursement requests (including corresponding invoices and available reimbursement methods) as feedback that may be used to dynamically update the reimbursement recommendation algorithm 206. Thus, the reimbursement recommendation algorithm 206 may be continuously updated, in real-time, as users select different reimbursement methods for corresponding reimbursement requests. By training the reimbursement recommendation algorithm 206 in real-time based on selections made by these sample users, the reimbursement recommendation algorithm 206 may reduce the number of user interactions with the claims reimbursement system 104 (e.g., by reducing the number of requests for new recommendations, by reducing processing of additional user inputs corresponding to alternative reimbursement methods, etc.) and, thereby, reduce the amount of processing required of the account processing sub-system 204 in providing relevant reimbursement method recommendations and processing requests for reimbursement according to selected reimbursement methods.

In an embodiment, the account processing sub-system 204 uses the digitized invoice 112 and account information corresponding to the reimbursement methods available to the user 110 (including any information obtained from the payment instrument service 108 and/or other entities associated with these reimbursement methods) to generate one or more reimbursement method recommendations that may be provided to the user 110 through the system interface 202. For instance, the account processing sub-system 204 may determine whether any of the available reimbursement methods associated with the user 110 cannot be used as a result of one or more applicable constraints. For instance, if a particular reimbursement method is unavailable as a result of this reimbursement method being inactive or invalid, the reimbursement recommendation algorithm 206 may not recommend this particular reimbursement method. Similarly, if a reimbursement applied according to a particular reimbursement method would result in a negative account balance, the reimbursement recommendation algorithm 206 may not recommend this particular reimbursement method. This may reduce the number of unnecessary user interactions with the claims reimbursement system 104, as the user 110 may be prevented from selecting different reimbursement methods that may be inactive or invalid that would otherwise result in processing of reimbursement requests that cannot be fulfilled.

In some instances, the reimbursement recommendation algorithm 206 may rank the available reimbursement methods according to a predicted likelihood of the user 110 selecting each of the available reimbursement methods for the reimbursement request. For instance, if the user 110, in their reimbursement request, has provided account information corresponding to a preferred reimbursement method, the reimbursement recommendation algorithm 206 may rank this particular reimbursement method higher than other available reimbursement methods if this particular reimbursement method is determined to be valid, active, and complies with any other applicable constraints. As another illustrative example, if the user 110 has historically used a particular reimbursement method for different reimbursement requests, and the particular reimbursement method is still available to the user 110, the reimbursement recommendation algorithm 206 may assign a higher rank to this particular reimbursement method compared to other reimbursement methods that may not have been previously used or with less frequency.

In an embodiment, when the user 110 accesses the claims reimbursement system 104 to submit their reimbursement request and the invoice 112, the account processing sub-system 204, through the reimbursement recommendation algorithm 206, can automatically evaluate any previously recorded reimbursement methods associated with the user's claims adjudication service 102 to generate an initial set of reimbursement method recommendations for the user 110 that may be presented to the user 110 through the system interface 202. Any known reimbursement methods associated with the user 110 that are deemed invalid for use (e.g., have no existing balance or would have a resulting negative balance, are inactive, etc.) may be omitted from the set of reimbursement methods presented to the user 110 and recommended by the reimbursement recommendation algorithm 206. This may prevent the user 110 from selecting a reimbursement method that may not be used for the present reimbursement request.

In some instances, if the user 110 provides account information corresponding to a new reimbursement method that may be used for the present reimbursement request, the reimbursement recommendation algorithm 206 may dynamically, and in real-time, update the initial set of reimbursement method recommendations based on an evaluation of the new reimbursement method in relation to the other reimbursement methods indicated in the initial set of reimbursement request recommendations. The account processing sub-system 204, for instance, may update the system interface 202 to present the updated set of reimbursement method recommendations to the user 110 for their reimbursement request. Further, the account processing sub-system 204 may query a payment instrument service associated with the new reimbursement method to determine whether the new reimbursement method can be used for the reimbursement request, as described above. Based on this determination, the account processing sub-system 204, through the reimbursement recommendation algorithm 206, may dynamically, and in real-time, update the initial set of reimbursement method recommendations.

In an embodiment, if the user 110 selects a reimbursement method corresponding to a payment instrument service 108 that the claims adjudication service 102 has an existing relationship with (e.g., the payment instrument service 108 and the claims adjudication service 102 are managed by the same provider, the payment instrument service 108 and the claims adjudication service 102 have established a trust relationship, etc.), the account processing sub-system 204 may transmit the user's selection and the reimbursement request to a reimbursement processing sub-system 208 implemented by the claims reimbursement system 104. The reimbursement processing sub-system 208 may be as an application or other executable process executed on one or more computer systems associated with the claims reimbursement system 104. In response to receiving the user's selection and the reimbursement request from the account processing sub-system 204, the reimbursement processing sub-system 208 may query the token vault 106 to determine whether a stored token corresponding to the selected reimbursement method is available for use. As noted above, a stored token may be provided by a payment instrument service 108 in exchange for a previously generated transaction token associated with a previously used payment instrument. A stored token may include a tokenized version of a payment instrument associated with the user 110 and may allow for continued retrieval of transaction tokens associated with the corresponding payment instrument. The stored token, in some instances, may be subject to an expiration date, whereby the stored token may be automatically expired once the expiration date has elapsed. The stored token may be stored within the token vault 106 within an entry corresponding to a pairing of the user's claims adjudication service 102 account and the payment instrument or other reimbursement method associated with the stored token. This may allow the reimbursement processing sub-system 208 to use any account information provided in the reimbursement request and/or the selection to query the token vault 106 for a stored token associated with the selected reimbursement method.

In an embodiment, if the reimbursement processing sub-system 208 determines that the token vault 106 does not maintain a stored token corresponding to the selected reimbursement method, the reimbursement processing sub-system 208 may transmit a request to the payment instrument service 108 to obtain a transaction token 114 that may be used to process the reimbursement request. For instance, the reimbursement processing sub-system 208 may call an API associated with the payment instrument service 108, through which the reimbursement processing sub-system 208 may provide account information provided by the account processing sub-system 204 and associated with the selected reimbursement method. In response to this API call, the payment instrument service 108 may use the provided account information to determine whether the provided account information corresponds to an active payment instrument account. If so, the payment instrument service 108 may return the transaction token 114 to the reimbursement processing sub-system 208.

In some embodiments, the query to the token vault 106 to determine the availability of the stored token associated with the selected reimbursement method and to obtain the transaction token 114 from the payment instrument service 108 may be performed by the account processing sub-system 204. For instance, prior to submitting the account search API call to the payment instrument service 108 to request additional account information associated with a selected payment instrument, the account processing sub-system 204 may query the token vault 106 to determine whether the token vault 106 maintains a stored token corresponding to the selected payment instrument. If the token vault 106 does not maintain a stored token for the selected payment instrument, the account processing sub-system 204 may transmit, in the account search API call, a request for a transaction token 114 that may be used to process the reimbursement to the account associated with the selected payment instrument. If the payment instrument service 108 returns a transaction token 114, and the account processing sub-system 204 determines that the reimbursement may be made to the account associated with the selected payment instrument, the account processing sub-system 204 may provide the transaction token 114 to the reimbursement processing sub-system 208.

If the token vault 106 maintains a stored token associated with the selected reimbursement method, the reimbursement processing sub-system 208 may transmit a request to the payment instrument service 108 to exchange the stored token for a transaction token 114 that may be used for the reimbursement request. The payment instrument service 108 may determine whether the stored token is valid. For instance, the payment instrument service 108 may determine whether the stored token has expired such that, if the stored token is expired, the request may be denied. Similarly, the payment instrument service 108 may determine whether the stored token is associated with an active payment instrument service account such that, if the corresponding account is inactive, the request may be denied. If the stored token is valid, the payment instrument service 108 may return a transaction token 114 that may be used for the present reimbursement request. This transaction token 114 may be maintained in the token vault 106 until the reimbursement request is made to the payment instrument service 108. Thus, the implementation of a stored token for a selected payment instrument may reduce the payload size of any API calls to the payment instrument service 108, thereby reducing the required network bandwidth for obtaining transaction tokens. Further, by using a stored token for a selected payment instrument, the amount of processing performed by the systems of the payment instrument service 108 is reduced, as these systems may not need to perform continued authentication of the claims reimbursement system 104 and evaluate payment instrument account information for generation of transaction tokens 114.

If the reimbursement processing sub-system 208 obtains a valid transaction token 114 for use with the reimbursement request, the reimbursement processing sub-system 208 may submit a reimbursement API call to the payment instrument service 108, using the transaction token 114 as the account identifier for the payment instrument account selected by the user 110. In addition to including the transaction token 114, the reimbursement processing sub-system 208, through the reimbursement API call, may provide information corresponding to the reimbursement request submitted by the user 110. This information may indicate the amount that is to be reimbursed to the user's payment instrument account, the reimbursement payment source (e.g., an account associated with the claims adjudication service 102, etc.), the claim number and/or other claim details as indicated in the invoice 112, and the like. In response to the reimbursement API call, the payment instrument service 108 may process the received transaction token 114 to identify the payment instrument account to which the reimbursement is to be made. Once the payment instrument account has been identified, the payment instrument service 108 may schedule the reimbursement payment to the payment instrument account, such as through ACH process as described above. The payment instrument service 108 may post the reimbursement to the user's payment instrument account such that, in a statement provided to the user 110 corresponding to this payment instrument, the reimbursement may be indicated.

If the token vault 106 does not maintain a stored token corresponding to the selected reimbursement method, the reimbursement processing sub-system 208 may transmit a request to the payment instrument service 108 to exchange the transaction token 114 for a stored token that may be maintained in the token vault 106. For instance, in response to receiving a notification from the payment instrument service 108 that the reimbursement request was processed successfully, the reimbursement processing sub-system 208 may transmit an API call to the payment instrument service 108 to exchange the transaction token 114 for a new stored token. In response to this API call, the payment instrument service 108 may dynamically generate a stored token that may be used to obtain future transaction tokens 114 for reimbursement requests associated with the corresponding payment instrument. This new stored token may be stored in the token vault 106 in association with the user's payment instrument account and the user's claims adjudication service account, as described above.

If the reimbursement request was processed successfully by the payment instrument service 108, the account processing sub-system 204 may dynamically update the reimbursement recommendation algorithm 206 such that, for similar reimbursement requests, reimbursement methods similar to the selected reimbursement method may be more likely to be recommended to users. Alternatively, if the payment instrument service 108 rejects a selected reimbursement method because the reimbursement would result in a negative balance for the corresponding payment instrument account, the account processing sub-system 204 may use this feedback to dynamically update the reimbursement recommendation algorithm 206 such that, for similar users and invoices, the likelihood of similar recommendations being provided is reduced. As another example, if the user 110 selects a reimbursement method that was not recommended by the account processing sub-system 204, the account processing sub-system 204 may update the reimbursement recommendation algorithm 206 such that, for similar users and invoices, the likelihood of the reimbursement recommendation algorithm 206 recommending similar reimbursement methods as that selected by the user 110 is increased. This process of updating the reimbursement recommendation algorithm 206 may be performed dynamically, and continuously, in real-time as reimbursement requests associated with different users and different medical events are received and as claims associated with these reimbursement requests are processed. Further, this process may be performed dynamically, and continuously, in real-time as feedback is received corresponding to the reimbursement method recommendations generated in response to reimbursement requests from different users and corresponding to different invoices. Thus, as the reimbursement recommendation algorithm 206 is dynamically updated based on this feedback (e.g., reimbursement method selections, responses from the payment instrument service 108 to submitted reimbursement requests, etc.), the number of unnecessary interactions between the users and the claims adjudication service 102 may be reduced. For instance, the retraining of the reimbursement recommendation algorithm 206 may result in the generation and presentation of relevant and appealing reimbursement recommendations that are less likely to be rejected by the payment instrument service 108 and by users, resulting in fewer recommendation iterations for individual reimbursement requests.

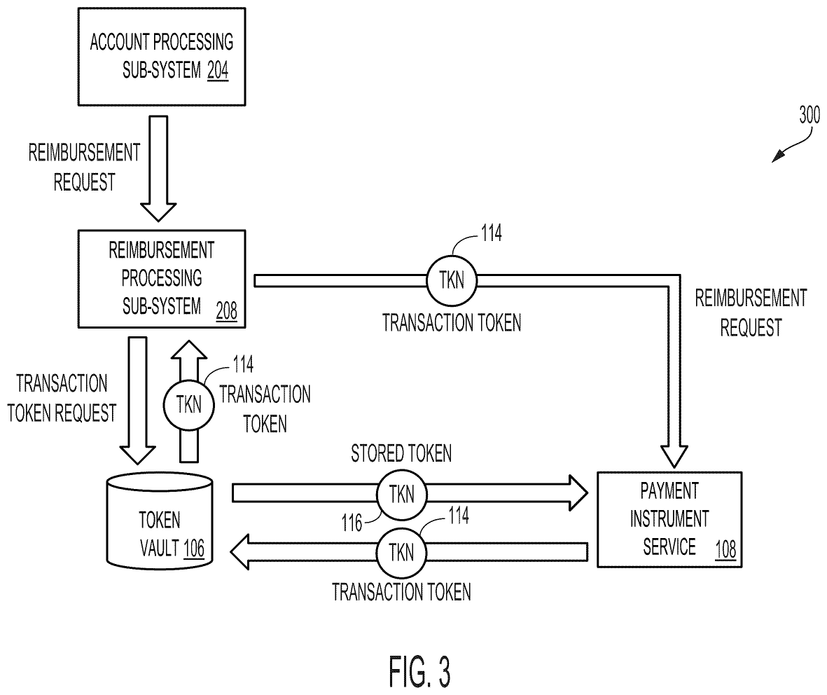

FIG. 3 shows an illustrative example of an environment 300 in which a reimbursement processing sub-system 208 obtains a transaction token 114 corresponding to an existing account for use in a reimbursement request to a payment instrument service 108 in accordance with at least one embodiment. In the environment 300, in response to a reimbursement request from an account processing sub-system 204, the reimbursement processing sub-system 208 may transmit a transaction token request to a token vault 106 to obtain a transaction token 114 that may be used to submit the reimbursement request to the payment instrument service 108. The transaction token request may include a query that includes account information corresponding to the selected reimbursement method. For instance, the transaction token request may include a PAN corresponding to a payment instrument account selected as the reimbursement method for the reimbursement request. As another illustrative example, the transaction token request may include identifying information associated with the user (e.g., username, legal name, electronic mail address, physical address, etc.), the type of payment instrument associated with the reimbursement request (e.g., issuer of the payment instrument, etc.), account information corresponding to the user's claims adjudication service account, and the like.

Through the transaction token request, the reimbursement processing sub-system 208 may determine whether the token vault 106 maintains a stored token 116 corresponding to the payment instrument account associated with the reimbursement request. For instance, the reimbursement processing sub-system 208, through the transaction token request, may determine whether the token vault 106 maintains an entry corresponding to a pairing of the user's claims adjudication service account and the selected payment instrument account. If the reimbursement processing sub-system 208 determines that such an entry is not present in the token vault 106, the reimbursement processing sub-system 208 may determine that a stored token 116 is not available for the selected payment instrument account. Accordingly, the reimbursement processing sub-system 208 may transmit a request to the payment instrument service 108 to obtain a transaction token 114 for the reimbursement request, as described above. Similarly, if the reimbursement request processing sub-system 208 determines that an identified entry in the token vault 106 is not associated with a stored token 116 for the selected payment instrument account, the reimbursement processing sub-system 208 may transmit a request to the payment instrument service 108 to obtain a transaction token 114 that may be used to process the reimbursement request.

If the reimbursement processing sub-system 208 determines that the token vault 106 maintains a stored token 116 corresponding to the selected payment instrument account, the reimbursement processing sub-system 208, through the token vault 106, may transmit a request to the payment instrument service 108 to obtain a transaction token 114 for use in processing the reimbursement request. For instance, the reimbursement processing sub-system 208, through the token vault 106, may transmit an API call to the payment instrument service 108, to request generation of a new transaction token 114 that may be used to submit the reimbursement request to the payment instrument service 108. This API call may include the stored token 116 retrieved from the token vault 106.

In response to this API call, the payment instrument service 108 may evaluate the stored token 116 to determine whether the stored token 116 is valid. For instance, the payment instrument service 108 may determine whether the stored token 116 is expired such that, if the stored token 116 has expired, the request for a new transaction token 114 may be denied. If the stored token 116 has not expired, the payment instrument service 108 may further determine whether the stored token 116 corresponds to an active payment instrument account (e.g., the payment instrument account has not been closed or disabled, etc.). If the payment instrument account associated with the stored token 116 is inactive, the payment instrument service 108 may similarly deny the request for a new transaction token 114. As noted above, if the request to obtain a new transaction token 114 for the selected payment instrument account is denied, the account processing sub-system 204 may generate new reimbursement method recommendations that may be provided to the user for their reimbursement request. Additionally, or alternatively, the account processing sub-system 204 may prompt the user to define an alternative reimbursement method for the reimbursement request.

If the payment instrument service 108 determines that the stored token 116 is valid and that the payment instrument account associated with the stored token 116 is active for use, the payment instrument service 108 may generate and provide a new transaction token 114 that may be stored in the token vault 106 for use with the reimbursement request. As noted above, the transaction token 114 may have a short expiration window compared to that of the stored token 116. For instance, the transaction token 114 may have a one-day expiration window whereby if the transaction token 114 is not used within this one-day expiration window, the transaction token 114 may be automatically expired. The stored token 116 may alternatively have a longer expiration window (e.g., one year, two years, etc.) to allow for continued use of the stored token 116 to obtain transactions tokens for different reimbursement requests using the same payment instrument account associated with the stored token 116.

The reimbursement processing sub-system 208 may retrieve the newly generated transaction token 114 from the token vault 106 and use this transaction token 114 in its submission of the reimbursement request to the payment instrument service 108. As noted above, the reimbursement processing sub-system 208 may submit a reimbursement API call to the payment instrument service 108, using the transaction token 114 as the account identifier for the payment instrument account indicated in the reimbursement request. In addition to including the transaction token 114, the reimbursement processing sub-system 208, through the reimbursement API call, may provide information corresponding to the reimbursement request submitted by the user 110 (e.g., the amount that is to be reimbursed to the user's payment instrument account, the reimbursement payment source, the claim number and/or other claim details as indicated in the invoice 112, etc.). In response to the reimbursement API call, the payment instrument service 108 may process the received transaction token 114 to identify the payment instrument account to which the reimbursement is to be made. Once the payment instrument account has been identified, the payment instrument service 108 may schedule the reimbursement payment to the payment instrument account and post the reimbursement to the user's payment instrument account.

In an embodiment, once the transaction token 114 has been used in the reimbursement API call to the payment instrument service 108, the transaction token 114 is automatically expired such that the transaction token 114 cannot be used for future reimbursement requests. The transaction token 114 may be removed from the token vault 106 such that, in response to future transaction token requests, the token vault 106 may be required to transmit a request to the payment instrument service 108 for a new transaction token 114. The transaction token 114 may be automatically expired regardless of whether the reimbursement request is successfully processed by the payment instrument service 108.

In an embodiment, if the token vault 106 does not maintain a stored token 116 for the selected payment instrument account, requiring the reimbursement processing sub-system 208 to provide, to the payment instrument service 108) account information corresponding to the selected payment instrument account in order to obtain a transaction token 114, the reimbursement processing sub-system 208 may submit a request to the payment instrument service 108 to exchange the transaction token 114 for a stored token 116 that may be stored in the token vault 106. For instance, if the reimbursement request is processed successfully by the payment instrument service 108, and the token vault 106 does not maintain a stored token 116 corresponding to the payment instrument account associated with the reimbursement request, the reimbursement processing sub-system 208 may transmit an API call that includes the transaction token 114 and a merchant identifier (MID) corresponding to the claims adjudication service to the payment instrument service 108. The payment instrument service 108, in response to this API call, may dynamically generate a new stored token 116 corresponding to the payment instrument account and the claims adjudication service. Further, the payment instrument service 108 may define an expiration date for the stored token 116.

In response to receiving a new stored token 116 from the payment instrument service 108, the reimbursement processing sub-system 208 may store this stored token 116 in the token vault 106. For instance, the reimbursement processing sub-system 208 may generate a new entry in the token vault 106 corresponding to a pairing of the payment instrument account and the user's claims adjudication service account. The reimbursement processing sub-system 208 may consequently associate the newly generated stored token 116 with this new entry. If an entry corresponding to this pairing already exists within the token vault 106, the reimbursement processing sub-system 208 may dynamically update this entry to associate the stored token 116 with the entry. Any previous references to expired stored tokens may be removed from the entry such that the entry is only associated with the active and unexpired stored token 116.

As noted above, the implementation of stored tokens 116 may allow for continued retrieval of transaction tokens 114 associated with different payment instruments without having to repeatedly provide payment instrument account information through the API call to the payment instrument service 108. This may reduce the payload size of any API calls to the payment instrument service 108, thereby reducing the required network bandwidth for obtaining transaction tokens 114 for the submission of reimbursement requests. Further, by using a stored token 116, the amount of processing performed by the systems of the payment instrument service 108 is reduced, as these systems may not need to perform continued authentication of the claims reimbursement system and evaluate payment instrument account information for generation of transaction tokens 114. Further, through the implementation of stored tokens 116 and transaction tokens 114, the number of API calls including sensitive user information (e.g., payment instrument account information, user information, etc.) for authentication is further reduced, increasing the security of the reimbursement process.

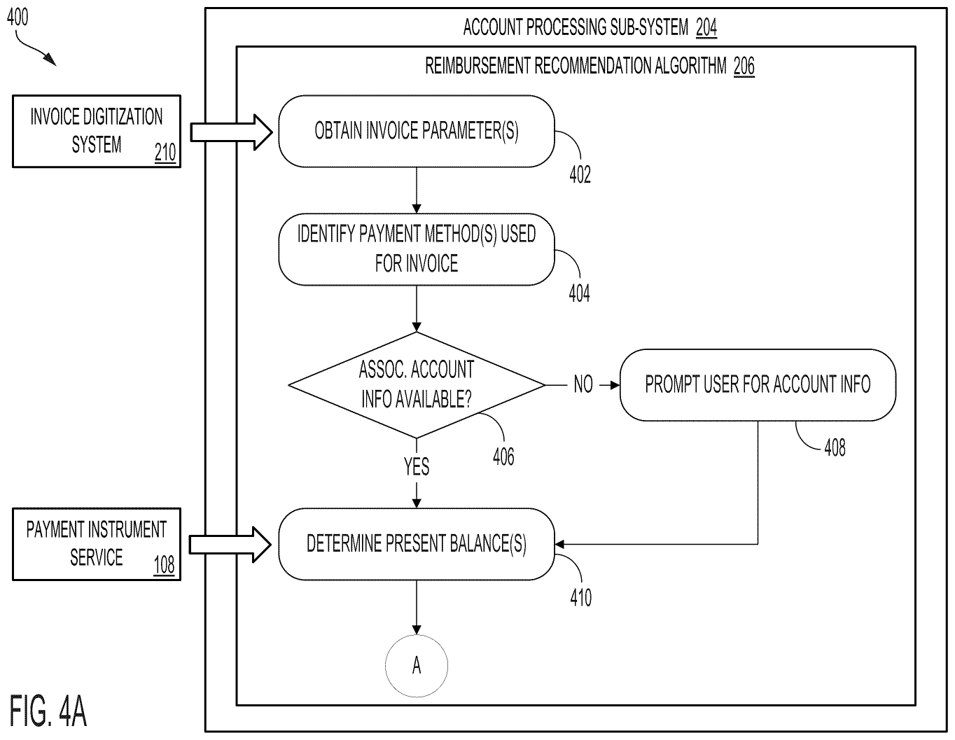

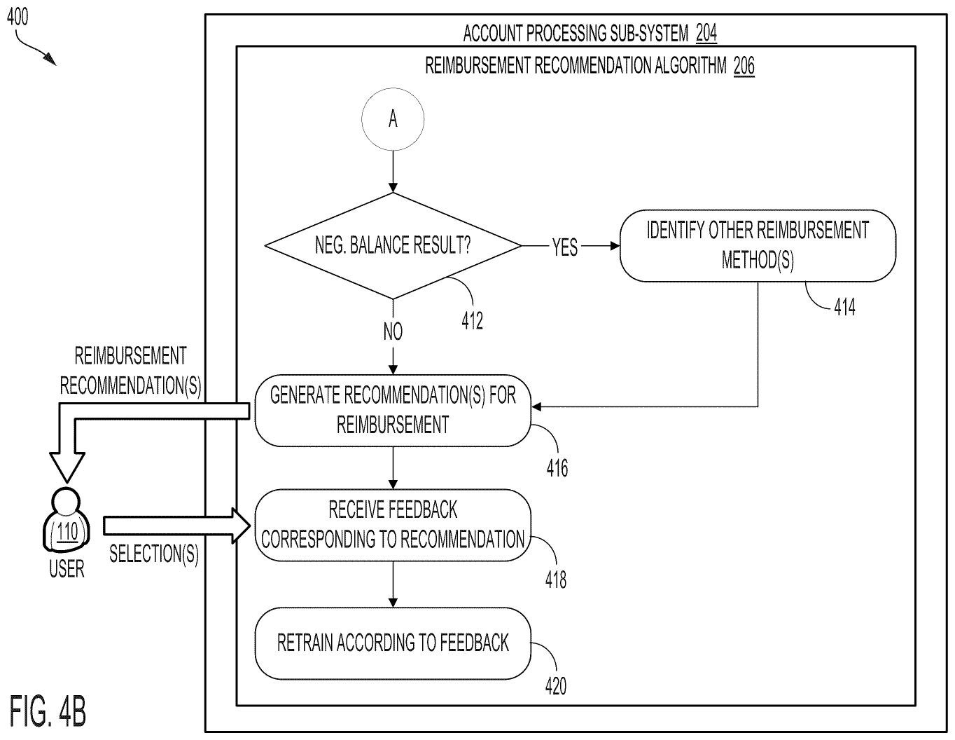

FIGS. 4A-4B show an illustrative example of an environment 400 in which a reimbursement recommendation algorithm 206 is dynamically trained to generate reimbursement recommendations according to invoice parameters and available reimbursement methods in accordance with at least one embodiment. In the environment 400, and as illustrated in FIG. 4A, the reimbursement recommendation algorithm 206 may, at step 402, obtain a set of invoice parameters corresponding to an invoice submitted by user and for which the user is requesting a reimbursement of an upfront payment made for goods and/or services indicated in the invoice. The invoice parameters may include, for example, treatments and/or procedures performed for the benefit of the user or other entity associated with the user. The invoice parameters may further include identifying information associated with the user or other entity for which the invoice was created. For instance, the invoice may provide the user's name, date of birth, address, contact information, and the like. If the treatments and/or procedures were performed for the benefit of an entity other than the user, the invoice may indicate the other entity's name, date of birth, address, contact information (if applicable), and the like. In some examples, the invoice parameters may further include identifying information associated with the provider of the treatments and/or procedures performed.

The invoice parameters, in an embodiment, further include information corresponding to any upfront payments made to the provider of the treatments and procedures performed. This information may include the amount of the upfront payment made by the user and information corresponding to the payment method used for the upfront payment. For instance, the invoice parameters may indicate whether the user provided an upfront payment using a particular payment instrument associated with a particular payment instrument provider. As an illustrative example, the invoice parameters may indicate one or more terms or phrases that denote the identity of the payment instrument service associated with the payment instrument provided by the user for the upfront payment. In some instances, the invoice parameters may indicate a portion of a PAN corresponding to a payment instrument account associated with the user. This portion of the PAN, in some instances, may be used to identify the payment instrument service associated with the payment instrument. For example, the portion of the PAN indicated in the invoice may include an IIN or BIN that uniquely identifies the payment instrument service.

At step 404, the reimbursement recommendation algorithm 206 may identify one or more payment methods used for the one or more upfront payments indicated on the invoice. As noted above, the invoice parameters extracted from the submitted invoice may indicate one or more terms or phrases denoting the identity of a payment instrument service associated with a payment method used to provide the upfront payment (e.g., an IIN, a BIN, terms or phrases that denote the identity of a payment instrument service, etc.). Accordingly, the reimbursement recommendation algorithm 206 may dynamically process these invoice parameters to detect the payment methods used by the user for the upfront payment and, accordingly, determine what additional information may be required for these payment methods in order to generate corresponding reimbursement method recommendations.

At step 406, based on the identified one or more payment methods used to provide an upfront payment, the reimbursement recommendation algorithm 206 may determine whether account information associated with these one or more payment methods is available. For instance, using the invoice parameters corresponding to the identified payment methods, the reimbursement recommendation algorithm 206 may query the user's claims adjudication service account to determine whether this claims adjudication service account includes additional account information corresponding to these payment methods. As noted above, when a user provides account information corresponding to a payment instrument account or other account to which a reimbursement is to be provided, the claims adjudication service may store this account information in the user's claims adjudication service account. Accordingly, if the provided invoice parameters correspond to an existing payment instrument account or other account associated with the user, the reimbursement recommendation algorithm 206 may automatically retrieve, from the claims adjudication service account, account information corresponding to the existing payment instrument account or other account associated with the user.

If the reimbursement recommendation algorithm 206 determines that the associated account information is not available within the user's claims adjudication service account, the reimbursement recommendation algorithm 206, at step 408, may prompt the user for this account information. For example, through the system interface 202 described above in connection with FIG. 2, the reimbursement recommendation algorithm 206 may indicate the invoice parameters detected by the reimbursement recommendation algorithm 206 as corresponding to a payment method used by the user to provide an upfront payment. Further, the reimbursement recommendation algorithm 206 may request the user, through the system interface 202, to provide the account information associated with this payment method so that the reimbursement request may be processed. In some instances, the user may opt to reject this request for additional information, which may result in the reimbursement recommendation algorithm 206 ignoring this particular payment method when generating reimbursement method recommendations for the received invoice.

At step 410, using the obtained account information for the upfront payment and any other account information corresponding to other available reimbursement methods defined by the user, the reimbursement recommendation algorithm 206 may determine the present balance for each of the corresponding accounts. For example, as noted above and for a given payment instrument account, the reimbursement recommendation algorithm 206 may transmit an account search API call to the payment instrument service 108 to request the present account balance for the payment instrument account and the OTB status of the payment instrument account. This account search API call may include the account information garnered from the user's claims adjudication service account and from the invoice parameters. In response to the account search API call, the payment instrument service 108 may return the account balance associated with the payment instrument account and an OTB response that indicates whether the payment instrument account is valid and available for use.

As illustrated in FIG. 4B, the reimbursement recommendation algorithm 206, at step 412, may determine whether reimbursement of the upfront payment would result in a negative balance to the payment instrument account. As noted above, the claims adjudication service may define a constraint whereby no reimbursement may be made to an account if the reimbursement would result in the account having a negative balance. Thus, for each identified payment instrument account for which an account balance has been determined, the reimbursement recommendation algorithm 206 may compare the reimbursement amount to the existing account balance for the payment instrument account to determine whether application of this reimbursement amount to the account would result in the account having negative balance. In some instances, the reimbursement recommendation algorithm 206 may further evaluate, for each of these payment instrument accounts, the OTB response provided by the corresponding payment instrument service 108 to determine whether the particular payment instrument account is valid and active for use. As noted above, by identifying any accounts having a negative balance, the reimbursement recommendation algorithm 206 may prevent transmission of impermissible API calls corresponding to reimbursement requests that, if fulfilled, would result in negative balances. Through this filtering of accounts having negative balances, the claims reimbursement system may limit and thereby reduce the processing performed by the payment instrument service 108 related to received reimbursement requests.

If the reimbursement recommendation algorithm 206 determines that a particular payment instrument account cannot be used as a reimbursement method for the received reimbursement request (e.g., the reimbursement would result in a negative account balance, the account is invalid, the account is inactive, etc.), the reimbursement recommendation algorithm 206 may identify one or more alternative reimbursement methods. For instance, the reimbursement recommendation algorithm 206 may query the user's claims adjudication service account to determine whether the user's claims adjudication service account includes account information corresponding to other types of accounts (e.g., checking accounts, savings accounts, brokerage accounts, etc.) to which reimbursements may be made without concern for constraint violations (e.g., negative account balance constraints, etc.). Further, the reimbursement recommendation algorithm 206 may identify other reimbursement methods through which a reimbursement may be provided without requiring an existing account for processing of the reimbursement. For instance, the reimbursement recommendation algorithm 206 may identify a reimbursement method whereby the user may be provided with a gift card, check, voucher, or other instrument corresponding to the reimbursement amount requested and that does not correspond to a pre-existing account.

At step 416, based on the evaluation of the invoice parameters, the identified one or more payment instrument accounts, and other available reimbursement methods that may be available to the user, the reimbursement recommendation algorithm 206 may generate a set of reimbursement method recommendations that may be presented to the user. For instance, the reimbursement recommendation algorithm 206 may rank the available reimbursement methods according to a predicted likelihood of the user 110 selecting each of the available reimbursement methods for the reimbursement request. Returning to an earlier illustrative example, if the user 110, in their reimbursement request, has provided account information corresponding to a preferred reimbursement method, the reimbursement recommendation algorithm 206 may rank this particular reimbursement method higher than other available reimbursement methods if this particular reimbursement method is determined to be valid, active, and complies with any other applicable constraints. As another illustrative example, if the user 110 has historically used a particular reimbursement method for different reimbursement requests, and the particular reimbursement method is still available to the user 110, the reimbursement recommendation algorithm 206 may assign a higher rank to this particular reimbursement method compared to other reimbursement methods that may not have been previously used or with less frequency. The reimbursement recommendation algorithm 206 may omit, from this ranking, any reimbursement methods that are otherwise unavailable (e.g., do not satisfy one or more of the applicable and aforementioned constraints, etc.).

The reimbursement recommendation algorithm 206 may provide these newly generated reimbursement recommendations to the user 110 through the aforementioned system interface 202. The user 110 may evaluate these reimbursement method recommendations and select one or more reimbursement methods for the reimbursement request. These one or more reimbursement methods may include one or more payment instrument accounts to which the reimbursement amount (or a portion of the reimbursement amount) may be credited. Based on the selections made by the user 110, the claims reimbursement system may process the reimbursement request in coordination with any applicable payment instrument services, as described above.

At step 418, the reimbursement recommendation algorithm 206 may receive feedback corresponding to the one or more reimbursement method recommendations provided by the reimbursement recommendation algorithm 206 to the user 110. For example, if the reimbursement recommendation algorithm 206 generated a recommendation for a payment instrument account and the reimbursement request is rejected by the payment instrument service 108 because the reimbursement would result in a negative account balance, the account processing sub-system 204 may use this feedback to, at step 420, dynamically retrain the reimbursement recommendation algorithm 206 such that, for similar users and invoices, the likelihood of similar recommendations being provided is reduced. As another example, if the user 110 selects a reimbursement method that was not recommended by the reimbursement recommendation algorithm 206, the account processing sub-system 204 may retrain, at step 420, the reimbursement recommendation algorithm 206 such that, for similar users and invoices, the likelihood of the reimbursement recommendation algorithm 206 recommending similar reimbursement methods as that selected by the user 110 is increased.

It should be noted the process executed by the reimbursement recommendation algorithm 206 (as illustrated in FIGS. 4A-4B) to generate reimbursement method recommendations may be dynamically, and continuously, performed in real-time as reimbursement requests (including corresponding invoices) associated with different users and different medical events are received and as the claims associated with these reimbursement requests are processed (e.g., reimbursements are made to selected accounts, reimbursement requests are rejected, etc.). Further, the reimbursement recommendation algorithm 206 may be dynamically, and continuously, updated in real-time as feedback is received corresponding to the reimbursement method recommendations generated in response to reimbursement requests from different users and corresponding to different invoices. As noted above, if the reimbursement recommendation algorithm 206 provides a reimbursement method recommendation that is not selected by a user 110 and the user 110 is successfully able to obtain a reimbursement according to their preferred reimbursement method, the account processing sub-system 204 may use the user's selection of this alternative and preferred reimbursement method as feedback to retrain the reimbursement recommendation algorithm 206. Similarly, if the user selects a recommended reimbursement method but their reimbursement request is later rejected by a payment instrument service or other service associated with the recommended reimbursement method, the account processing sub-system 204 may use this rejection as feedback that may be used to retrain the reimbursement recommendation algorithm 206 to decrease the likelihood of similar reimbursement methods being recommended for similarly situated users and corresponding invoices. Thus, as reimbursement requests and invoices are continuously received and processed for myriad users, the account processing sub-system 204 may dynamically, and in real-time, continuously update the reimbursement recommendation algorithm 206 to increase its accuracy in automatically generating reimbursement method recommendations associated with these reimbursement requests.

As noted above, as the reimbursement recommendation algorithm 206 is dynamically updated based on this feedback (e.g., reimbursement method selections, responses from the payment instrument service 108 to submitted reimbursement requests, etc.), the number of unnecessary interactions between the users and the claims adjudication service may be reduced. For instance, the retraining of the reimbursement recommendation algorithm 206 according to the received feedback may result in the generation and presentation of relevant and appealing reimbursement recommendations that are less likely to be rejected by the payment instrument service 108 and by different users, resulting in fewer recommendation iterations for individual reimbursement requests and in fewer unnecessary user interactions with the claims adjudication service.

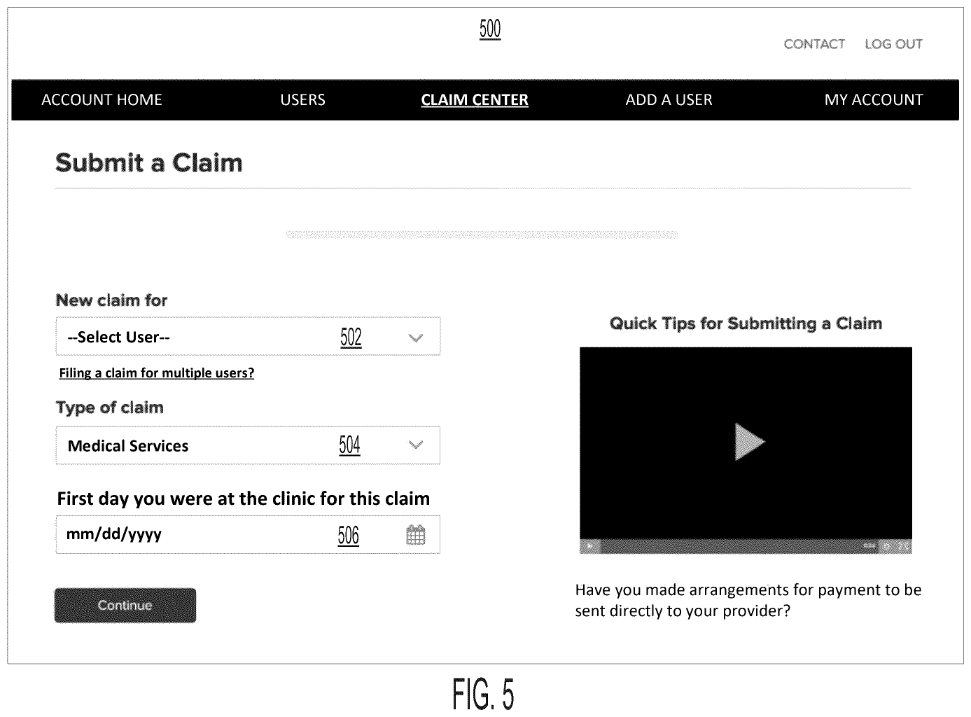

FIG. 5 shows an illustrative example of an interface 500 through which a user can initiate submission of a claim for reimbursement in accordance with at least one embodiment. The interface 500 may be provided through the system interface 202 described above in connection with FIG. 2. For instance, a user may access the interface 500 through a website or web portal provided by the claims adjudication service for submission of different claims related to treatments and procedures performed for which the user may wish to be reimbursed subject to an existing medical coverage plan and for which the user has provided an upfront payment to the provider of the treatments and procedures performed. Alternatively, the user may access the interface 500 through an application provided by the claims adjudication service and executed on a computing device associated with the user (e.g., a mobile device, a standalone computer, etc.). The application may be further executed on a computing device associated with a service provider or retailer (e.g., a kiosk implemented at a doctor's office or other location where treatments and procedures are performed, etc.).

Through the interface 500, the claims adjudication service may provide a user with various options for defining a reimbursement request that may be processed by the claims reimbursement system, as described above. For instance, as illustrated in FIG. 5, the claims adjudication service may provide an entity identification drop down menu 502, which the user of the interface 500 may select the entity for which the claim and reimbursement request is being submitted. In an embodiment, when the user accesses the interface 500, the claims reimbursement system may access a claims adjudication service account associated with the user to identify any entities associated with one or more corresponding insurance policies provisioned by the user for these entities. To access this claims adjudication service account, the claims adjudication service may prompt the user to provide a set of credentials (e.g., username and password, cryptographic key or token, etc.) that may be used to authenticate the user and to identify an existing account associated with the user. In some instances, if the user does not maintain an account with the claims adjudication service but otherwise has provisioned one or more insurance policies through a policy provider associated with the claims adjudication service, the claims adjudication service may prompt the user to provide identifying information corresponding to the insurance policy (e.g., policy number, etc.), which the claims adjudication service may use to identify the insurance policy and the corresponding insured entities. Through this identification, the claims adjudication service may update the entity identification drop down menu 502 to provide selection options for each of these insured entities.

The claims adjudication service, through the interface 500, may further provide a type of claim selection menu 504, through which the user may define the type of claim being submitted. The claims adjudication service, through the type of claim selection menu 504, may provide the user with various pre-defined options corresponding to different types of claims that may be submitted to the claims adjudication service. As illustrated in FIG. 5, the user has selected, from the type of claim selection menu 504, “Medical Services” from the myriad pre-defined options provided by the claims adjudication service. The options provided through the type of claim selection menu 504 may correspond to the different services, treatments, and procedures that may be covered by an insurance provider through issuance of different insurance policies to users.

In an embodiment, the options provided through the type of claim selection menu 504 are automatically identified according to the insurance policy applicable to the user or other entity selected through the entity identification drop menu 502. For instance, when the user selects, from the entity identification drop menu 502, an entity for which the claim and reimbursement request is being submitted, the claims adjudication service may automatically evaluate any insurance policies associated with the selected entity to identify the medical treatments and/or procedures that may be covered for the entity subject to any deductibles defined in these policies. Accordingly, based on this evaluation of the applicable policies, the claims adjudication service may update the type of claim selection menu 504 to provide different options corresponding to the types of claims that may be covered by the corresponding insurance policies. In some instances, the evaluation of the insurance policies associated with the user may be evaluated without selection of an insured entity through the entity identification drop menu 502 such that the user, through the type of claim selection menu 504, may select the type of claim being submitted without selecting an insured entity from the entity identification drop menu 502.

The claims adjudication service, through the interface 500, may further provide a claim date identification menu 506, through which the user may define the date in which the claimed treatments and/or procedures were performed. In some instances, if the user selects the claim date identification menu 506, the claims adjudication service may automatically update the interface 500 to present an interactive calendar. Through this interactive calendar, the user may select the particular date corresponding to submitted claim and on which the claimed treatments and/or procedures were performed. In some instances, the user may manually define the claim date through the claim date identification menu 506. For instance, the user may use the claim date identification menu 506 as an input field through which the user may enter the month, day, and year corresponding to the date in which the claimed treatments and/or procedures were performed.

In an embodiment, the claims adjudication service can automatically select on behalf of the user the different inputs for the entity identification drop down menu 502, the type of claim selection menu 504, and the claim date identification menu 506 based on an automated evaluation of the invoice submitted by the user. As noted above, the claims adjudication service, through the claims reimbursement system, may implement an OCR processor that can automatically scan a provided invoice to automatically, and in real-time, identify any text included in the invoice and to generate a digitized version of the invoice. The digitization of the invoice may be performed by the OCR processor using an OCR process, whereby the invoice is digitized into a machine-readable format to allow for discernment of textual elements from the invoice.

In some instances, the OCR processor may include one or more NLP algorithms that are dynamically trained in real-time to process digitized versions of received invoices to extract elements useful in identifying any relevant terms corresponding to upfront payments made for indicated treatments and/or procedures. The OCR processor, through these one or more NLP algorithms, may dynamically and in real-time process a received invoice to extract the different inputs for the menus 502-506 described above. These extracted inputs may be presented to the user through the interface 500. This may allow the user to review the extracted inputs and make any changes based on the user's understanding of the claim being submitted. Any changes made by the user through the menus 502-506 for the present claim may be used as feedback that may be used to dynamically, and in real-time, retrain the one or more NLP algorithms. For instance, if the OCR processor updates the entity identification drop menu 502 to present the name of an entity that is not associated with the claim, and the user uses the entity identification drop menu 502 to select the appropriate entity associated with the claim, the OCR processor may use this correction as feedback that may be used to retrain the one or more NLP algorithms to improve the accuracy of these one or more NLP algorithms in identifying the entities associated with submitted invoices. In some instances, if the user concurs with the inputs provided by the one or more NLP algorithms and opts to continue with submission of the claim and reimbursement request, the OCR processor may use this concurrence as feedback that may be used to dynamically reinforce, in real-time, the one or more NLP algorithms.

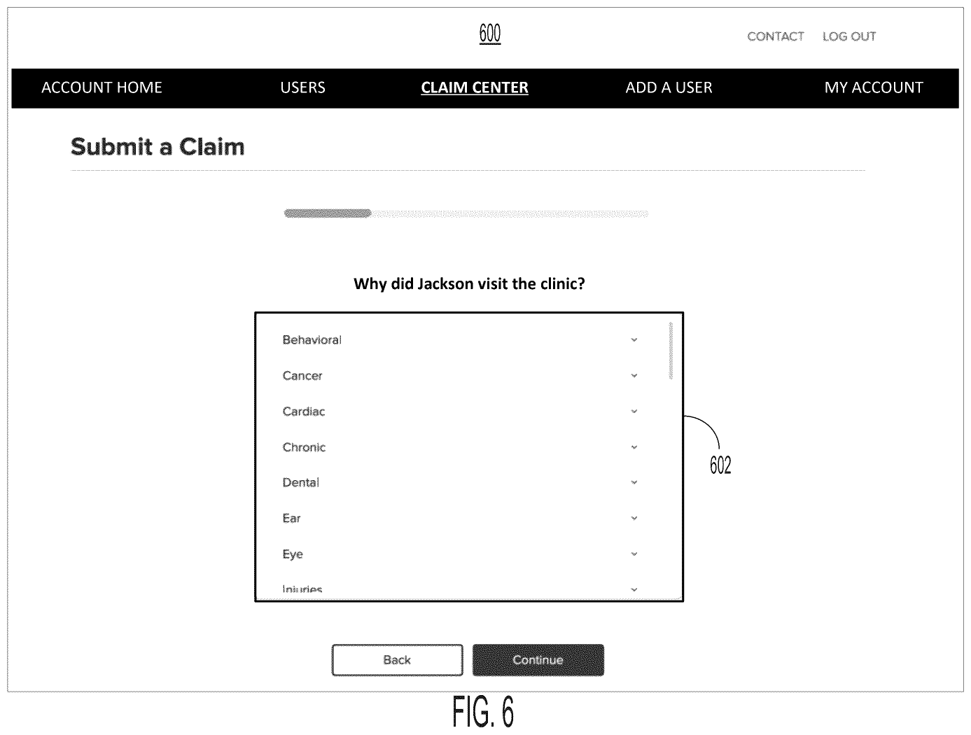

FIG. 6 shows an illustrative example of an interface 600 through which a user can select one or more conditions associated with the claim being submitted for reimbursement in accordance with at least one embodiment. The interface 600 may be provided through the system interface 202 described above in connection with FIG. 2. In some instances, the interface 600 may represent a continuation of the claims and reimbursement request submission process initiated by a user through the interface 500 described above in connection with FIG. 5. Through the interface 600, the claims adjudication service may provide a medical cause selection window 602, through which the claims adjudication service may provide the user with various options corresponding to different reasons for which the insured entity was taken to a service provider and for which the medical treatments and/or procedures were provided.

The different options presented through the medical cause selection window 602 may be pre-defined by the claims adjudication service based on the different conditions and causes that may be covered by insurance policies issued by an insurance provider associated with the claims adjudication service. In an embodiment, the different options presented through the medical cause selection window 602 can be identified based on the automatic evaluation of the one or more insurance policies associated with the insured entity, as identified through the interface 500 described above in connection with FIG. 5. As noted above, when the user selects an entity for which the claim and reimbursement request is being submitted, the claims adjudication service may automatically evaluate any insurance policies associated with the selected entity to identify the medical treatments and/or procedures that may be covered for the entity subject to any deductibles defined in these policies. Additionally, the claims adjudication service may identify any pre-existing conditions associated with the insured entity. The insurance policy associated with the insured entity may not be applicable for pre-existing conditions that may have been known to the user and to the policy provider at the time of the issuance of the insurance policy. For example, the insurance policy provider may automatically deny any claims for reimbursement related to treatments and/or procedures associated with conditions that pre-dated the issuance of the insurance policy. Thus, for any pre-existing conditions or other conditions/medical causes that are not covered by the identified insurance policy, the claims adjudication service may automatically omit these conditions and medical causes from the medical cause selection window 602.

As noted above, the claims adjudication service, through an OCR processor, may automatically scan a provided invoice to automatically, and in real-time, identify any text included in the invoice and to generate a digitized version of the invoice. The OCR processor, through one or more NLP algorithms, may dynamically and in real-time process a received invoice to extract terms and phrases corresponding to the conditions or other medical causes that led to the insured entity requiring medical assistance and the procedures/treatments indicated in the provided invoice. Accordingly, the claims adjudication service may automatically update the medical cause selection window 602 to present the one or more conditions or other medical causes identified by the OCR processor through evaluation of the digitized version of the invoice using the aforementioned one or more NLP algorithms. This may allow the user to review the extracted inputs (e.g., identified conditions or other medical causes) and make any changes based on the user's understanding of the claim being submitted.

If the user makes any changes to the one or more conditions or other medical causes identified through the one or more NLP algorithms and presented through the medical cause selection window 602, the OCR processor may record these changes as feedback that may be used to dynamically, and in real-time, retrain the one or more NLP algorithms. For instance, if the OCR processor updates the medical cause selection window 602 to present a particular condition not associated with the claim, and the user uses the medical cause selection window 602 to select the appropriate condition associated with the claim, the OCR processor may use this correction as feedback that may be used to retrain the one or more NLP algorithms to improve the accuracy of these one or more NLP algorithms in identifying the one or more conditions or other medical causes associated with submitted invoices. In some instances, if the user concurs with the inputs provided by the one or more NLP algorithms and opts to continue with submission of the claim and reimbursement request, the OCR processor may use this concurrence as feedback that may be used to dynamically reinforce, in real-time, the one or more NLP algorithms.

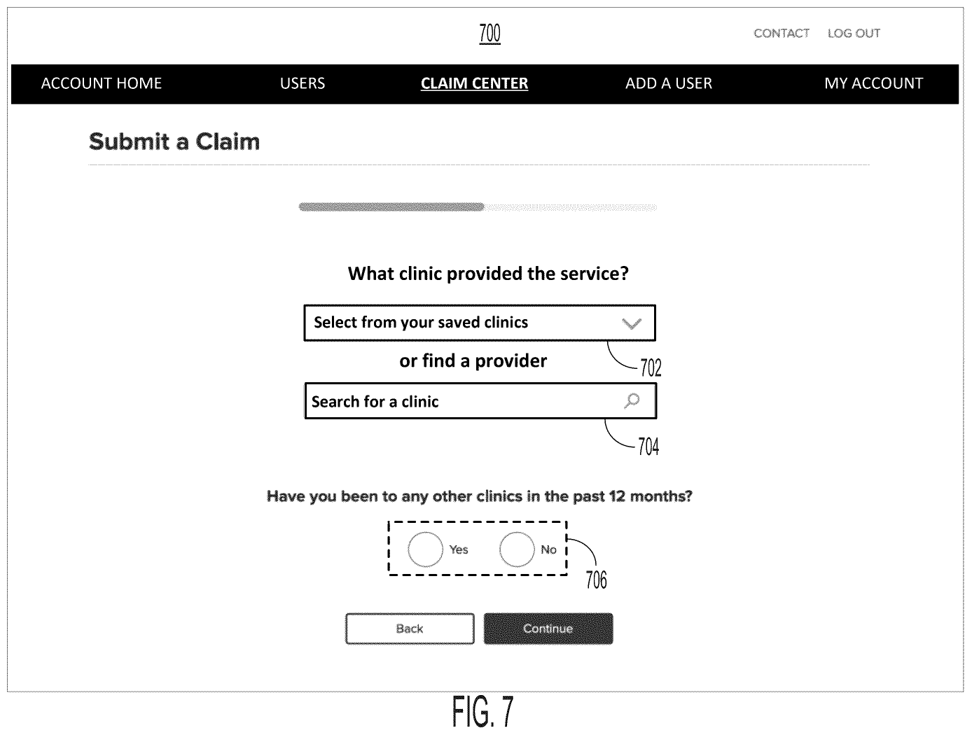

FIG. 7 shows an illustrative example of an interface 700 through which a user can provide information corresponding to a provider associated with the claim being submitted for reimbursement in accordance with at least one embodiment. The interface 700 may be provided through the system interface 202 described above in connection with FIG. 2. In some instances, the interface 700 may further represent a continuation of the claims and reimbursement request submission process initiated by a user through the interface 500 described above in connection with FIG. 5. Through the interface 700, the claims adjudication service may prompt the user to provide identifying information corresponding to the provider of the treatments and/or procedures indicated in the claim being submitted (as defined through the interface 600 described above in connection with FIG. 6 and/or the invoice corresponding to the claim). For instance, as illustrated in FIG. 7, the claims adjudication service may provide a saved providers drop down menu 702, through which the claims adjudication service may present the user with different options corresponding to different providers associated with the user's claims adjudication service account.

To identify the different providers that may be associated with the user's claims adjudication service account, the claims adjudication service may evaluate this account to identify any providers that may have been associated with previous claims submitted by the user. For instance, a claims adjudication service account may include a record of historical claims previously submitted for different treatments and/or procedures performed for different conditions. These historical claims may include identifying information corresponding to the different providers that performed the indicated treatments and/or procedures. Based on an evaluation of these historical claims, the claims adjudication service may generate, through the saved providers drop down menu 702, a listing or other ordering of providers associated with these historical claims. In some instances, the claims adjudication service may narrow the listing or ordering of providers according to the insured entity indicated by the user, such as through the entity identification drop down menu 502 described above in connection with FIG. 5. For instance, the claims adjudication service may evaluate, from the user's claims adjudication service account, any historical claims corresponding to the identified entity and, based on these historical claims, identify the providers associated with the claims associated with the identified entity.

In an embodiment, the claims adjudication service, through the interface 700, allows the user to submit a search query for identifying information corresponding to the provider that performed the treatments and/or procedures associated with the present claim. For instance, through the interface 700, the claims adjudication service may provide a provider search query field 704 through which the user may input one or more terms that may be used to identify a provider for the present claim. As the user enters one or more terms into the provider search query field 704, the claims adjudication service may, in real-time, query a database of known providers to identify a set of providers that correspond to these one or more terms. This database of known providers may include entries corresponding to different providers that are affiliated with the insurance policy provider (are within the provider network) and for which claims may be submitted. Additionally, the database of known providers may include entries corresponding to providers that may not be affiliated with the insurance policy provider (outside the provider network) but that have historically been cited in claims for different treatments and/or procedures. Additionally, or alternatively, the claims adjudication service may submit the one or more terms as these are provided by the user through the provider search query field 704 to one or more third-party search engines. These one or more third-party search engines may maintain their own databases corresponding to providers within different geographic areas. The results from the database of known provider and/or the one or more third-party search engines may be provided to the user through the provider search query field 704.

In an embodiment, the claims adjudication service, through an OCR processor, can automatically scan a provided invoice to automatically, and in real-time, identify generate a digitized version of the invoice and identify a provider of the treatments and/or procedures indicated in the invoice. For instance, the OCR processor, through one or more NLP algorithms, may dynamically and in real-time process a received invoice to extract terms and phrases corresponding to a provider of the procedures/treatments indicated in the provided invoice. Accordingly, the claims adjudication service may automatically update the interface 700 to present identifying information corresponding to the provider identified by the OCR processor through evaluation of the digitized version of the invoice using the aforementioned one or more NLP algorithms. This may allow the user to review the extracted inputs (e.g., identified provider) and make any changes based on the user's understanding of the claim being submitted.

If the user selects a provider other than the one identified through the one or more NLP algorithms and presented through the interface 700, the OCR processor may record this selection as feedback that may be used to dynamically, and in real-time, retrain the one or more NLP algorithms. For instance, if the OCR processor updates the interface 700 to present a particular provider not associated with the claim, and the user uses the saved providers drop down menu 702 and/or the provider search query field 704 to select the appropriate provider associated with the claim, the OCR processor may use this correction as feedback that may be used to retrain the one or more NLP algorithms to improve the accuracy of these one or more NLP algorithms in identifying the providers associated with submitted invoices. In some instances, if the user concurs with the selection of a provider provided by the one or more NLP algorithms and opts to continue with submission of the claim and reimbursement request, the OCR processor may use this concurrence as feedback that may be used to dynamically reinforce, in real-time, the one or more NLP algorithms.

As illustrated in FIG. 7, the interface 700 may further include options 706 for indicating whether the insured entity has visited other medical providers over a past time period. For example, the claims adjudication service may prompt the user, through the options 706, to indicate whether the insured entity (as indicated through the entity identification drop down menu 502 described above in connection with FIG. 5) has visited any other medical providers over the past twelve months. These options 706 may be provided by the claims adjudication service for claims adjudication determinations. For instance, if the user indicates that the insured entity has visiting another provider over a past time period, the user may not be entitled to the full reimbursement amount being requested per the applicable insurance policy. In some instances, the applicable insurance policy may prohibit multiple visits to providers for the same condition over a particular span of time. Thus, based on the constraints defined in the insurance policy associated with the insured entity, the claims adjudication service may generate different options 706 for responding to prompts for additional information usable to make claims adjudication determinations.

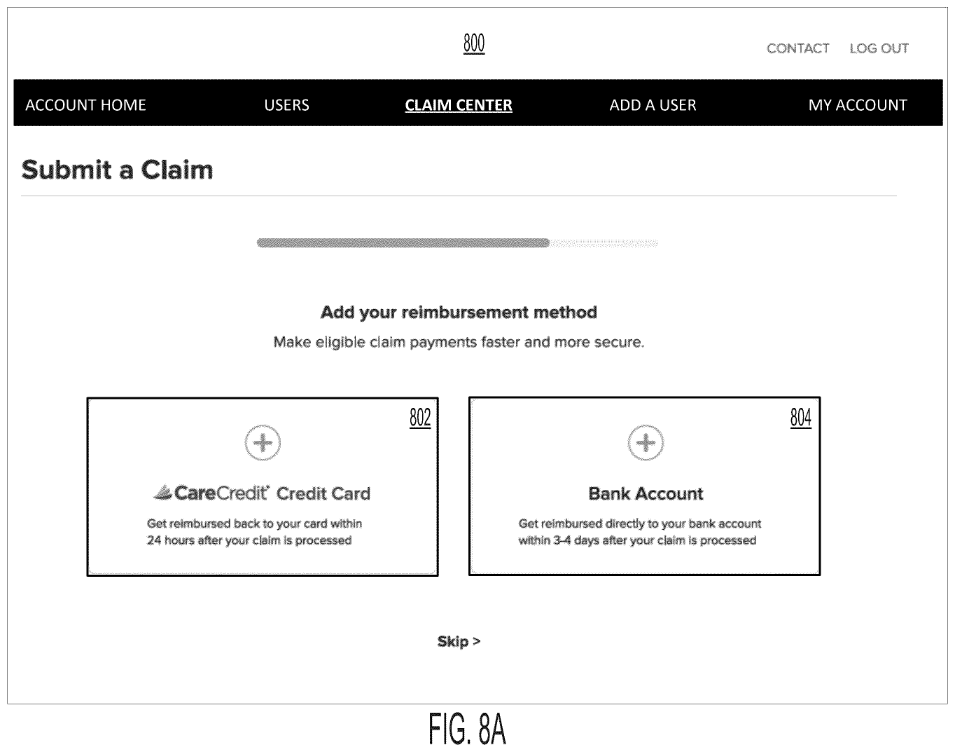

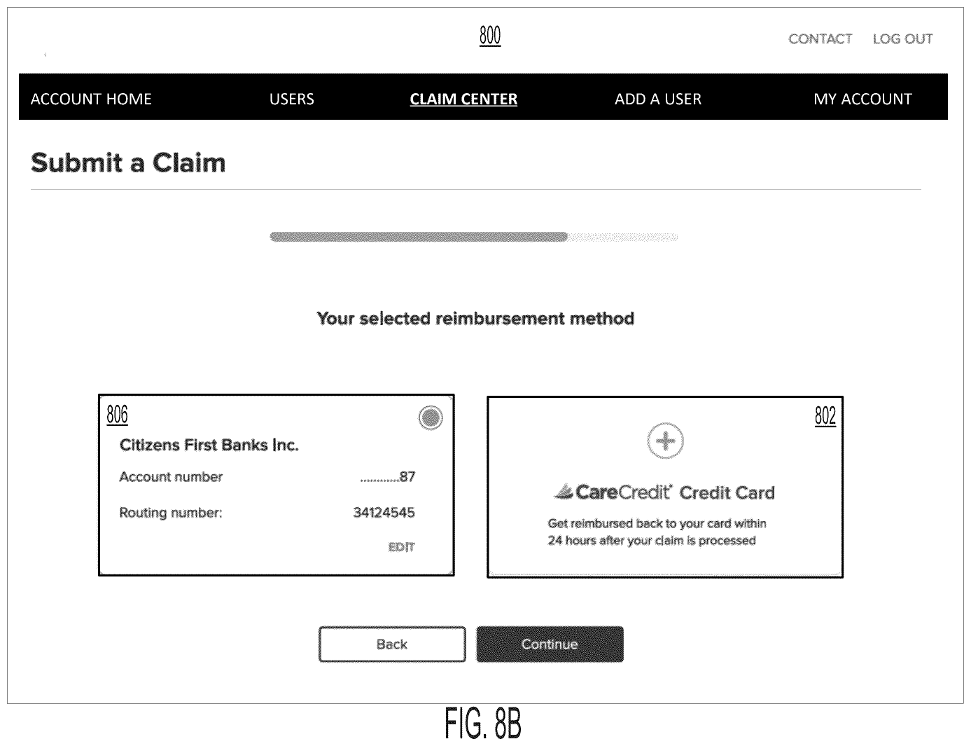

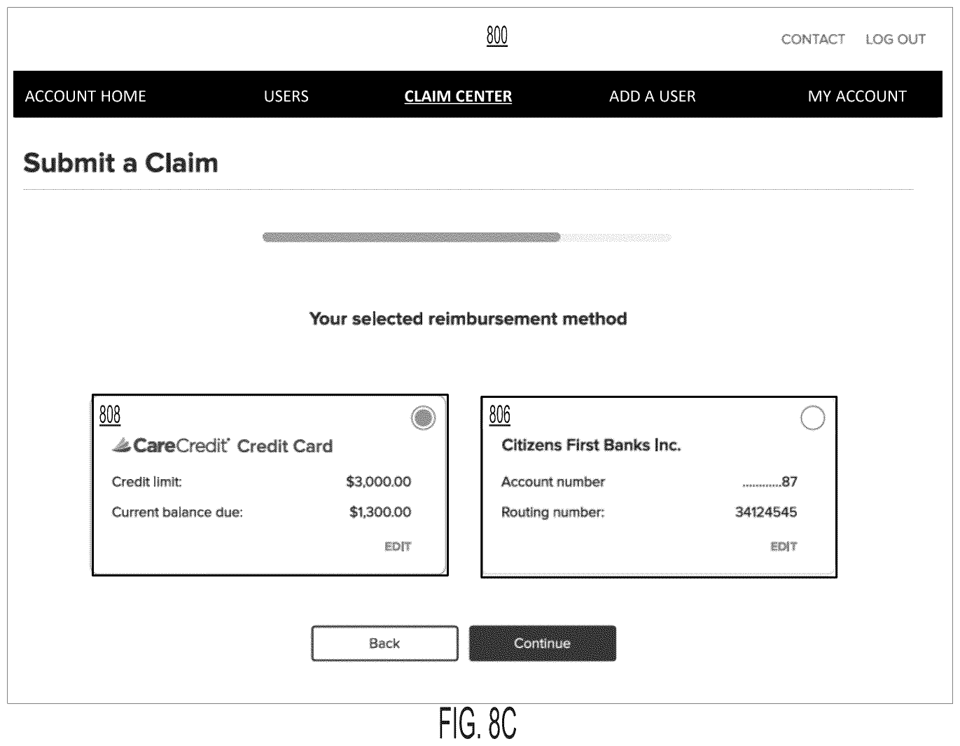

FIGS. 8A-8C show an illustrative example of an interface 800 through which a user can introduce and select a particular reimbursement method for a claim being submitted for reimbursement in accordance with at least one embodiment. As noted above, the claims adjudication service, through the claims reimbursement system, may automatically access the user's existing claims adjudication service account or other record corresponding to previous reimbursement requests associated with the insured entity to identify any available reimbursement methods associated with the insured entity and/or user submitting the reimbursement request. These available reimbursement methods may correspond to existing payment instrument accounts, existing checking accounts associated with one or more banks or other financial institutions, existing savings accounts associated with one or more banks or other financial institutions, and the like.

As illustrated in FIG. 8A, the claims adjudication service, through the interface 800, may prompt the user to define one or more reimbursement methods for the reimbursement request being submitted by the user. The interface 800 illustrated in FIG. 8A may be presented to the user if the claims adjudication service determines that there are no existing reimbursement methods associated with the user's claims adjudication service account. Accordingly, the user may be required to define at least one reimbursement method for their reimbursement request. As illustrated in FIG. 8A, the claims adjudication service may provide the user with an option 802 to select a payment instrument account as their preferred reimbursement method and to provide identifying information corresponding to this payment instrument account. The option 802 may correspond to a particular payment instrument service that the claims adjudication service has a pre-existing relationship with, such as the payment instrument service 108 described above in connection with FIGS. 1-3.

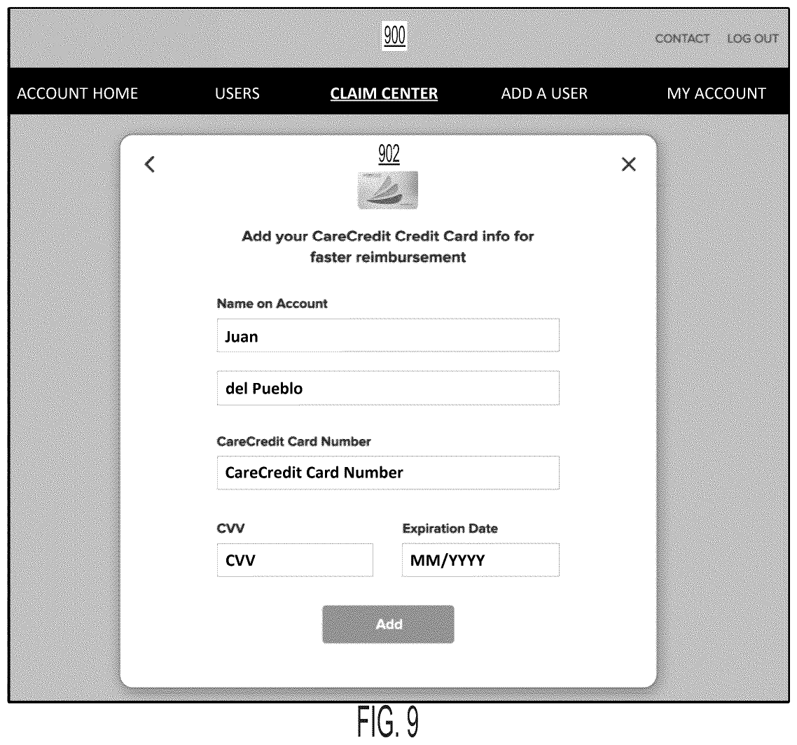

If the user selects the option 802, the claims adjudication service may update the interface 800 to prompt the user to provide account information corresponding to their payment instrument account. This prompt for account information is described in greater detail herein in connection with FIG. 9. Once the user has supplied the requested account information corresponding to their payment instrument account, the claims reimbursement system may query the token vault maintained by the claims adjudication service to determine whether a stored token corresponding to this payment instrument account is maintained within the token vault. If so, the claims reimbursement system may determine that the indicated payment instrument account is active and may be used for processing of reimbursement requests.

In some instances, in addition to querying the token vault to determine the availability of a stored token corresponding to the payment instrument account, the claims reimbursement system may transmit an account search API call to the payment instrument service associated with this account to determine the present account balance for the account and to obtain an OTB response. As noted above, the claims reimbursement system may determine whether the requested reimbursement amount exceeds that of the existing balance associated with a selected payment instrument account (e.g., the reimbursement would result in a negative account balance). Further, based on the OTB response, the claims reimbursement system may determine whether the payment instrument account selected by the user is valid and active for use. If the claims reimbursement system determines that the selected payment instrument account is not available for use (e.g., the reimbursement would result in a negative account balance, the payment instrument account is inactive, etc.), the claims reimbursement system may update the interface 800 to indicate that the payment instrument account selected by the user through the option 802 cannot be used for the reimbursement request.

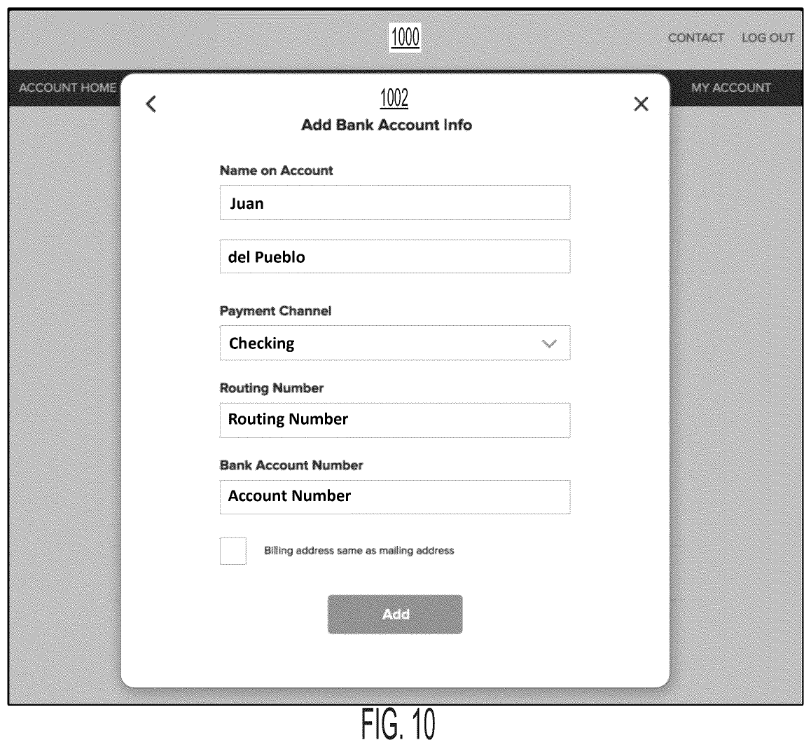

As illustrated in FIG. 8A, in addition to providing an option 802 to provide account information corresponding to a payment instrument account associated with an affiliated payment instrument service, the claims adjudication service may provide an option 804 to provide account information corresponding to a bank account or other financial institution account (e.g., a checking account, a savings account, a brokerage account, etc.) associated with one or more banks or other financial institutions. If the user selects the option 804, the claims adjudication service may update the interface 800 to prompt the user to provide account information corresponding to their financial institution account. This prompt for account information is described in greater detail herein in connection with FIG. 10.

In some instances, the claims adjudication service may determine that the user's claims adjudication account is associated with an existing financial institution account. For example, the user may have previously selected this financial institution account for a previous reimbursement request that was successfully processed by the claims adjudication service. As noted above, the claims adjudication service may record, within the user's claims adjudication service account, account information corresponding to any previously defined payment instrument service accounts and financial institution accounts. This account information may be defined by the user, such as through submission of reimbursement requests and/or an onboarding processing associated with the claims adjudication service.

In an embodiment, if the claims adjudication service determines that the user's claims adjudication account is associated with an existing financial institution account, the claims adjudication service may provide, through the interface 800, an option for selecting this existing financial institution account as the preferred reimbursement method for the present claim. For example, as illustrated in FIG. 8B, the claims adjudication service may present an option 806 corresponding to an existing financial institution account associated with the user. Within this option 806, the claims adjudication service may present, to the user, the name of the financial institution (e.g., “Citizens First Banks Inc.”), one or more portions of the account number associated with the account, one or more portions of the routing number associated with the financial institution, and the like. The claims adjudication service, through the option 806, may further allow the user to edit the account information indicated for the particular financial institution account. For instance, if the account information is outdated (e.g., the routing number associated with the financial institution has changed, the financial institution account has been closed, etc.), the user may edit the indicated account information to provide updated account information corresponding to their financial institution account.

As illustrated in FIG. 8B, the claims adjudication service may continue to provide, through the interface 800, an option 802 to provide account information corresponding to a payment instrument account associated with an affiliated payment instrument service. The option 802 may be provided to the user through the interface 800 if the claims adjudication service determines that the user has not previously linked their payment instrument account to their claims adjudication service account. As noted above, if the user selects the option 802 to provide account information associated with their payment instrument account, the claims adjudication service may update the interface 800 to prompt the user to provide account information corresponding to their payment instrument account. This prompt for account information is described in greater detail herein in connection with FIG. 9. Further, the claims adjudication service may determine whether the payment instrument account indicated by the user through the option 802 is valid for use with the reimbursement request (e.g., the reimbursement would not result in a negative account balance, the payment instrument account is active for use, etc.).

In some instances, the claims adjudication service may determine that the user has both an existing payment instrument account and an existing financial institution account that are linked to the user's claims adjudication service. Accordingly, as illustrated in FIG. 8C, the claims adjudication service may provide, through the interface 800, an option 806 corresponding to an existing financial institution account associated with the user and an option 808 corresponding to an existing payment instrument account associated with the user. As noted above, the option 806 may include the name of the financial institution associated with the account, one or more portions of the account number associated with the account, one or more portions of the routing number associated with the financial institution, and the like. Further, through the option 806, the claims adjudication service may allow the user to update any account information corresponding to the presented financial institution account.

The option 808 corresponding to an existing payment instrument account, as illustrated in FIG. 8C, may include the name of the payment instrument service associated with the payment instrument account. Additionally, the option 808 may indicate the current credit limit and account balance associated with the payment instrument account. As noted above, the claims reimbursement system implemented by the claims adjudication service, using account information associated with the payment instrument account, may submit an account search API call to the payment instrument service to obtain the current balance for the payment instrument, the OTB response (e.g., determination as to whether the payment instrument is valid and active for use), and the like. Using this information from the payment instrument service, the claims adjudication service, through the option 808, may present the current account balance, credit limit, and other account information associated with the payment instrument account. This may allow the user to determine whether to select the payment instrument account as the preferred reimbursement method for the present claim and reimbursement request.

In an embodiment, in response to receiving the current balance for the payment instrument account and the OTB response, the claims adjudication service may determine whether to present the option 808 for the payment instrument account. For instance, if the reimbursement amount, as indicated by the user through the interface and/or the invoice submitted by the user, exceeds the current balance for the payment instrument account (e.g., the reimbursement would result in a negative balance), the claims adjudication service may determine that the payment instrument account may not be used for the reimbursement request. Accordingly, the claims adjudication service may omit the option 808 from the interface 800 in order to require the user to select an alternative reimbursement method for the claim. As another illustrative example, if the claims adjudication service determines, based on the received OTB response, that the payment instrument account is inactive or otherwise unavailable for use (e.g., the payment instrument account has been frozen due to detected fraudulent activity, etc.), the claims adjudication service may omit the option 808 from the interface 800. This may prevent transmission of impermissible API calls corresponding to reimbursement requests that would not be fulfilled (e.g., inactive accounts, accounts unavailable for use, etc.) and reimbursement requests that, if fulfilled, would result in negative balances. Through this filtering of reimbursement methods according to received data for the different reimbursement methods available to the user, the claims reimbursement system may limit and thereby reduce the processing performed by the payment instrument service related to received reimbursement requests. Further, through this filtering of reimbursement methods, the claims reimbursement system may reduce the number of unnecessary user interactions with the interface 800 that would result in unfulfilled reimbursement requests and revisions to the reimbursement methods available to users.

It should be noted that the options 802-808 described above in connection with FIGS. 8A-8C are illustrative example of options that may be presented to a user through the interface 800 for selection of a preferred reimbursement method for the claim being submitted to the claims adjudication service. Accordingly, in some instances, additional and/or alternative options may be generated and provided to the user through the interface 800. For example, in an embodiment, the options presented to the user through the interface 800 are provided according to reimbursement method recommendations dynamically generated, in real-time, through the reimbursement recommendation algorithm 206 described above in connection with FIGS. 2 and 4A-4B. As noted above, the reimbursement recommendation algorithm 206 may be initially trained using a selection from a dataset of sample invoices (e.g., historical invoices corresponding to different users, hypothetical invoices corresponding to hypothetical users, etc.), known available reimbursement methods for the sample invoices, and selections made from these known available reimbursement methods. Further, the reimbursement recommendation algorithm 206 may be dynamically trained in real-time on reimbursement method selections made by the sample users. Based on the inputs provided by the user corresponding to the present claim and reimbursement request (e.g., an invoice, selection of a preferred reimbursement method, account information corresponding to different payment instrument and/or financial institution accounts, information corresponding to an applicable insurance policy, information corresponding to the insured entity corresponding to the claim being submitted, etc.), the reimbursement recommendation algorithm 206 may dynamically, and in real-time, generate a set of reimbursement method recommendations that may be presented to the user through one or more options similar to those illustrated in FIGS. 8A-8C.

As noted above, in some instances, the reimbursement recommendation algorithm 206 may rank the set of reimbursement method recommendations and other available reimbursement methods according to a predicted likelihood of the user selecting each of the available reimbursement methods for the reimbursement request. For instance, if the user, in their reimbursement request, has provided account information corresponding to a preferred reimbursement method, the reimbursement recommendation algorithm may rank this particular reimbursement method higher than other available reimbursement methods if this particular reimbursement method is determined to be valid, active, and complies with any other applicable constraints. As another illustrative example, if the user has historically used a particular reimbursement method for different reimbursement requests, and the particular reimbursement method is still available to the user, the reimbursement recommendation algorithm may assign a higher rank to this particular reimbursement method compared to other reimbursement methods that may not have been previously used or with less frequency.

The ranking generated by the reimbursement recommendation algorithm 206 may be presented to the user through the interface 800. For instance, options corresponding to highly ranked reimbursement methods may be more prominently displayed through the interface 800 such that the user may be more enticed to select a more highly ranked reimbursement method as opposed to a reimbursement method that may have a lower ranking or was otherwise not recommended by the reimbursement recommendation algorithm 206. In some instances, the claims adjudication service, based on the ranking generated by the reimbursement recommendation algorithm 206, may provide one or more incentives to the user for selecting a highly ranked reimbursement method. For instance, if the reimbursement recommendation algorithm 206 ranks a user's payment instrument account associated with an affiliated payment instrument service highly, the claims adjudication service may provide one or more incentives to the user if the user selects the option corresponding to this payment instrument account. These one or more incentives may include loyalty rewards, coupons, gifts, discounts for future services associated with the account, etc.

Any selections made by the user through the interface 800 may be used, in real-time or near real-time, to dynamically update the reimbursement recommendation algorithm 206. As noted above, the reimbursement recommendation algorithm 206 may be dynamically, and continuously, updated in real-time as claims and reimbursement requests associated with different users and different medical events are received and as these claims and reimbursement requests are processed. Further, the reimbursement recommendation algorithm 206 may be dynamically, and continuously, updated in real-time as selections are made through the interface 800 from the options generated and presented to users in response to reimbursement requests from these different users and corresponding to different invoices. For instance, if an option generated by the reimbursement recommendation algorithm 206 and presented through the interface 800 is not selected by a user and the user is successfully able to obtain a reimbursement according to an alternative reimbursement method, the claims adjudication service may use the user's selection of this alternative reimbursement method as feedback to retrain the reimbursement recommendation algorithm 206. As another illustrative example, if the user selects, from the interface 800, an option generated by the reimbursement recommendation algorithm 206, and the reimbursement request is later rejected by a payment instrument service or financial institution associated with the selected option, the claims adjudication service may use this rejection as feedback that may be used to retrain the reimbursement recommendation algorithm 206 to decrease the likelihood of similar options being presented for similarly situated users and/or claims. Thus, as claims and corresponding reimbursement requests are continuously received and processed for different users, the claims adjudication service may dynamically, and in real-time, continuously update the reimbursement recommendation algorithm 206 to increase its accuracy in automatically generating recommendations and corresponding options based on provided claim and reimbursement request inputs.

FIG. 9 shows an illustrative example of an interface 900 through which a user can provide account information corresponding to an existing payment instrument account for use as a reimbursement method for different claims in accordance with at least one embodiment. The interface 900 illustrated in FIG. 9 may be presented to the user in response to selection of an option to link an existing payment instrument account with their claims adjudication service account. For example, the claims adjudication service may present the interface 900 to the user in response to the user's selection of option 802 as illustrated in FIGS. 8A-8B.

Through the interface 900, the claims adjudication service may present an account information window 902 through which the user may provide account information corresponding to their payment instrument account. For instance, as illustrated in FIG. 9, through the account information window 902, the claims adjudication service may prompt the user to provide the account holder's name (as presented on the payment instrument or otherwise associated with the account), the PAN or other account number associated with the payment instrument account, the CVV or other security code associated with the payment instrument, and the expiration date of the payment instrument associated with the account. In some instances, the claims adjudication service, through the account information window 902, may allow the user to scan their payment instrument through one or more peripheral devices (e.g., camera, scanner, etc.) implemented on their computing device to provide the requested account information. The claims adjudication service, through the account information window 902, may provide a capture window through which the user may view, in real-time, the images being captured through their peripheral devices and determine whether the payment instrument and corresponding account information is visible to the claims adjudication service.

If the claims adjudication service allows the user to scan their payment instrument through one or more peripheral devices, the claims adjudication service may use computer vision or other machine learning algorithm/artificial intelligence to process the real-time images being captured through the user's peripheral devices to detect the payment instrument and obtain any available information associated with the payment instrument. For example, the claims adjudication service may process the video feed reproduced through the capture window using computer vision to identify the payment instrument within the video feed. Further, using computer vision, the claims adjudication service may identify, from the payment instrument, the corresponding PAN or other account number, the payment instrument holder's name, the expiration date for the payment instrument, and any other information that may be required to identify the payment instrument account (e.g., a CVV or other security code, a logo or trademark associated with the financial institution that provided the payment instrument, etc.). In an embodiment, as the claims adjudication service, through the use of computer vision or other machine learning algorithm/artificial intelligence, captures information corresponding to the payment instrument that the user wishes to register with the claims adjudication service, the claims adjudication service can determine whether additional information is required. For example, if the information captured for the payment instrument does not include the CVV or other security code associated with the payment instrument (e.g., the CVV or other security code may be located on the reverse side of the payment instrument), the claims adjudication service may prompt the user, through account information window 902, to flip the payment instrument to the reverse side to capture the CVV or other security code.

Once the claims adjudication service has obtained, through the account information window 902, the requisite information associated with an unregistered payment instrument account that the user wishes to link to their claims adjudication service account, the claims adjudication service may update the interface 900 to present an option corresponding to the newly linked payment instrument account. This option may be similar to the option 808 described above in connection with FIG. 8C. In an embodiment, prior to providing this option, the claims adjudication service, through the account search API exposed by the payment instrument service, may transmit the obtained information to the payment instrument service to obtain the current balance and OTB status of the account. As noted above, the claims adjudication service may use the current balance and OTB status associated with the payment instrument account to determine whether the reimbursement associated with the claim may be issued to this account. For instance, if the requested reimbursement would result in the payment instrument account having a negative balance, the claims adjudication service may determine that the requested reimbursement cannot be made to the account. Similarly, if the claims adjudication service determines, based on the OTB status of the account, that the payment instrument account is inactive or otherwise unavailable for use, the claims adjudication service may determine that the requested reimbursement cannot be made to this account. If the claims adjudication service determines that the reimbursement cannot be made to the indicated payment instrument account, the claims adjudication service may not generate an option to select this payment instrument account for the reimbursement request.

FIG. 10 shows an illustrative example of an interface 1000 through which a user can provide account information corresponding to an existing account associated with a financial institution for use as a reimbursement method for different claims in accordance with at least one embodiment. The interface 1000 illustrated in FIG. 10 may be presented to the user in response to selection of an option to link an existing payment instrument account with an account associated with a particular financial institution. For instance, the user may wish to link their claims adjudication service account to an existing checking account, savings account, brokerage account, and the like. The claims adjudication service may present the interface 1000 to the user in response to the user's selection of option 804 as illustrated in FIG. 8A.

Through the interface 1000, the claims adjudication service may present an account information window 1002 through which the user may provide account information corresponding to their financial institution account. For instance, as illustrated in FIG. 10, through the account information window 1002, the claims adjudication service may prompt the user to provide the account holder's name (as associated with the financial institution account), the payment channel associated with the account (e.g., checking, savings, brokerage, etc.), the routing number corresponding to the financial institution associated with the financial institution account, and the account number associated with the financial institution account.

Similar to the interface 900 described above in connection with FIG. 9, the claims adjudication service, through the account information window 1002, may allow the user to scan any instruments associated with their financial institution account (e.g., checks, debit cards, etc.) through one or more peripheral devices (e.g., camera, scanner, etc.) implemented on their computing device to provide the requested account information. The claims adjudication service, through the account information window 1002, may provide a capture window through which the user may view, in real-time, the images being captured through their peripheral devices and determine whether the instrument and corresponding account information is visible to the claims adjudication service.

If the claims adjudication service allows the user to scan an instrument associated with their financial institution account through one or more peripheral devices, the claims adjudication service may use computer vision or other machine learning algorithm/artificial intelligence to process the real-time images being captured through these one or more peripheral devices to detect this instrument and obtain any available information associated with the instrument. Similar to the illustrative example described above in connection with FIG. 9, the claims adjudication service may process the video feed reproduced through the capture window using computer vision to identify the payment instrument within the video feed. Further, using computer vision, the claims adjudication service may identify, from the instrument associated with the financial institution, the routing number associated with the financial institution, the account number associated with the user's financial institution account, the user's name and address, and the like.

Once the user has provided, through the account information window 1002, the requisite account information for linking their financial institution account to their claims adjudication service account, the claims adjudication service may update the interface 1000 to present an option corresponding to the newly linked financial instrument account. This option may be similar to the option 806 described above in connection with FIGS. 8B-8C. As reimbursements to financial institution accounts may be provided in the form of deposits, reimbursements would not result in negative account balances for these account. Thus, the claims adjudication service may not be required to determine the present account balance of the defined financial instrument account. However, in some instances and prior to providing the option 806 as described above, the claims adjudication service may query the indicated financial institution to determine whether the indicated financial institution account is active and available for use. For instance, if the financial instrument account has been frozen such that the financial instrument account is unable to accept any deposits, the claims adjudication service may determine that the financial instrument account cannot be used as a reimbursement method for the present claim and reimbursement request. Similarly, if the financial instrument service determines that the account has been terminated or is not associated with the financial institution (e.g., the financial institution has no record of the specified account, etc.), the claims adjudication service may determine that the specified financial instrument account is invalid for use. Accordingly, the claims adjudication service may forego generating an option, such as option 806, for selection of the financial instrument account for the claim and corresponding reimbursement request.

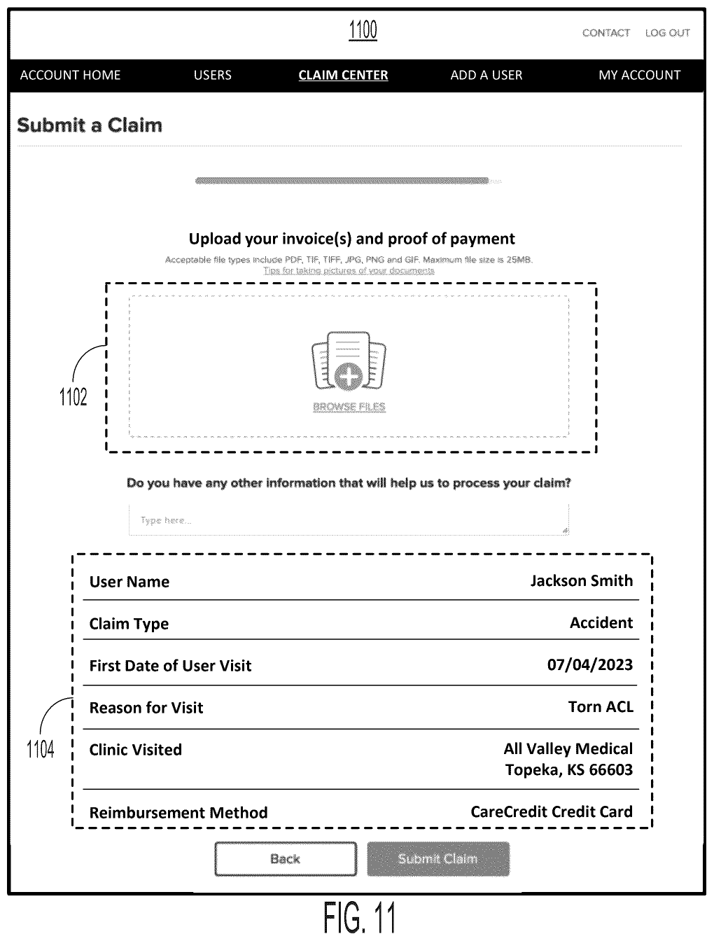

FIG. 11 shows an illustrative example of an interface 1100 through which a user can upload an invoice and proof of payment corresponding to a new claim to obtain reimbursement for the claim in accordance with at least one embodiment. The interface 1100 may be provided through the system interface 202 described above in connection with FIG. 2. In some instances, the interface 1100 may further represent a continuation of the claims and reimbursement request submission process initiated by a user through the interface 500 described above in connection with FIG. 5. Through the interface 1100, the claims adjudication service may prompt the user to provide any invoices and corresponding proofs of payment for the treatments and/or procedures associated with the claim being submitted. For instance, as illustrated in FIG. 1100, the claims adjudication service may provide a document upload window 1102, through which the claims adjudication service may allow the user to upload digital versions of any invoices and proofs of payment associated with the claim being submitted.

If the user selects the document upload window 1102, the claims adjudication service may transmit executable instructions to the user's computing device to cause the user's computing device to execute a file manager through which the user may select one or more documents for upload to the claims adjudication service. For instance, if the user selects the document upload window 1102, the user's computing device may automatically present, over the interface 1100, a file manager window, through which the user may explore the directories and files maintained on the user's computing device. Through the file manager window, the user may select one or more documents that may be uploaded to the claims adjudication service to support their claim.

In an embodiment, the claims adjudication service, in response to receiving one or more documents through the document upload window 1102, scans the one or more documents using an OCR processor (such as OCR processor 212 described above in connection with FIG. 2) to identify any parameters that may correspond to an invoice and/or proof of payment for the claim being submitted. For instance, the OCR processor, through one or more NLP algorithms, may dynamically and in real-time process a received invoice to extract terms and phrases corresponding to a provider of the procedures/treatments indicated in the provided invoice. Further, the OCR processor, through these one or more NLP algorithms, may dynamically and in real-time process the received invoice to extract terms and phrases corresponding to the insured entity that received the procedures/treatments indicated in the provided invoice. The OCR processor, through the one or more NLP algorithms, may further identify information corresponding to the medical cause for the visit to the provider, the date of the visit, the address or other location information associated with the provider, and the type of claim being submitted.

In an embodiment, the OCR processor, through the aforementioned one or more NLP algorithms, can also dynamically and in real-time process the uploaded invoice and any proofs of payment (e.g., receipts, statements, etc.) to extract and terms and phrases corresponding to the payment method used for the invoice and the amount paid using the selected payment method. For example, the OCR processor, through the one or more NLP algorithms, may evaluate the submitted invoice and any proofs of payment to identify the payment instrument or financial institution instrument (e.g., debit card, check, etc.) used to provide the indicated payment. In some instances, the OCR processor may identify a portion of a PAN or other account identifier corresponding to an account associated with the user that was used to provide the upfront payment. This portion of the PAN or other account identifier, in some instances, may be used to identify the payment instrument service or financial institution service associated with the payment method used to provide the upfront payment. For example, a portion of the PAN indicated in the invoice may include an IIN or BIN that uniquely identifies a payment instrument service or financial institution service. As another illustrative example, if the invoice or proofs of payment indicate a routing number associated with a financial institution, the OCR processor may use this routing number to identify the financial institution associated with the payment method used to provide the upfront payment.

In an embodiment, selection of the document upload window 1102 causes the claims adjudication service to transmit executable instructions to the user's computing device to initiate one or more peripheral devices that may be used to scan any documents that the user wishes to provide to supplement their claim. The claims adjudication service, through the document upload window 1102, may provide a capture window through which the user may view, in real-time, the images being captured through their peripheral devices and determine whether the invoice and/or proofs of payment are visible to the claims adjudication service. If the claims adjudication service allows the user to scan their invoice and/or proofs of payment through one or more peripheral devices, the claims adjudication service may use computer vision or other machine learning algorithm/artificial intelligence to process the real-time images being captured through the user's peripheral devices to detect any required information associated with the claim being submitted. For example, the claims adjudication service may process the video feed reproduced through the capture window using computer vision to identify the different parameters associated with the claim being submitted (e.g., the name of the insured entity, the type of claim, the provider of the treatments/procedures performed, the date of the visit to the provider, address or other location information associated with the provider, any upfront payments provided by the user, the payment method used for the upfront payments, etc.).

In an embodiment, as the claims adjudication service, through the use of computer vision or other machine learning algorithm/artificial intelligence, captures information corresponding to the claim that the user wishes to submit to the claims adjudication service, the claims adjudication service can determine whether additional information is required. For example, if the information captured for the claim does not include the name of the provider of the treatments/procedures indicated on the submitted invoice, the claims adjudication service may prompt the user, through the interface 1100, to input the name of the provider and any other information that may be used to identify the provider. As another illustrative example, if the information captured for the claim does not include any indication of the payment method used for an indicated upfront payment amount, the claims adjudication service, through the document upload window 1102, may prompt the user to upload or scan any documents that may serve as the proof of payment for the upfront payment amount indicated on the provided invoice.

In an embodiment, once the claims adjudication service has obtained, through the document upload window 1102, the required invoice and/or proofs of payment for the claim being submitted, the claims adjudication service may update the interface 1100 to present, through a summary window 1104, a summary of the claim and reimbursement request being submitted. For example, as illustrated in FIG. 11, based on the information submitted by the user through the various interfaces described above in connection with FIGS. 5-7, 8A-8C, and 9-10, as well as any information garnered through the documents submitted by the user through the document upload window 1102, the claims adjudication service, through the summary window 1104, may present the required information submitted by the user for their claim and reimbursement request. This required information, as illustrated in FIG. 11 through the summary window 1104, may include the name of the insured entity for which the claim is being submitted, the type of claim, the date of the visit to the provider of the indicated treatments and/or procedures, the reason for the visit to the provider, identifying information associated with the provider (e.g., the provider name, the address or other location information of the provider, etc.), and the reimbursement method selected by the user or otherwise associated with the upfront payment submitted for the claim.

In some instances, the claims adjudication service, through the summary window 1104, may allow the user to edit any information indicated within the summary window 1104 prior to submission of their claim and reimbursement request. For instance, if the summary window 1104 indicates the incorrect insured entity for the claim, the user may select, through the summary window 1104, an option to correct the name of the insured entity for the claim. This may allow the user, for example, to return to the interface 500 described above in connection with FIG. 5, to indicate the correct insured entity for the claim being submitted. As another illustrative example, if the user wishes to change the reimbursement method for their claim and reimbursement request, the user may select, through the summary window 1104, an option to edit the reimbursement method for their claim and reimbursement request. This may cause the claims adjudication service to present, to the user, the interface 800 described above in connection with 8A-8C to allow the user to select a different reimbursement method or correct any account information corresponding to the selected reimbursement method for their claim and reimbursement request.

In an embodiment, if any of the information presented through the summary window 1104 was dynamically and automatically obtained by the claims adjudication service through one or more machine learning algorithms or artificial intelligence, and the user made one or more corrections to this information, the claims adjudication service can use these corrections as feedback that is used to dynamically update these one or more machine learning algorithms or artificial intelligence. As an illustrative example, if the information provided through the summary window 1104 was obtained using an OCR processor and one or more corresponding NLP algorithms, and the user determines that the incorrect insured entity has been identified, the claims adjudication service may record the user's correction of the insured entity as feedback that may be used to dynamically retrain the one or more NLP algorithms to more accurately identify, from submitted invoices and proofs of payment, the correct insured entity.

It should be noted that, in some instances, the interface 1100 may be presented prior to any of the other interfaces described above in connection with FIGS. 5-7, 8A-8C, and 9-10. For instance, if the user, through the document upload window 1102, provides an invoice and any proofs of payment for the upfront payment submitted for provided treatments/procedures, the claims adjudication service, using the aforementioned OCR processor and corresponding NLP algorithms, may obtain any required information for the claim and reimbursement request being submitted. If the user is satisfied with the information indicated through the summary window 1104, the user may select an option to submit the claim and reimbursement request without interacting with any of the interfaces described above in connection with FIGS. 5-7, 8A-8C, and 9-10. However, in some instances, the user may access these interfaces if the user needs to make any corrections to the information indicated through the summary window 1104, the user needs to additional information, and/or the user wishes to select an alternative reimbursement method for their reimbursement request.

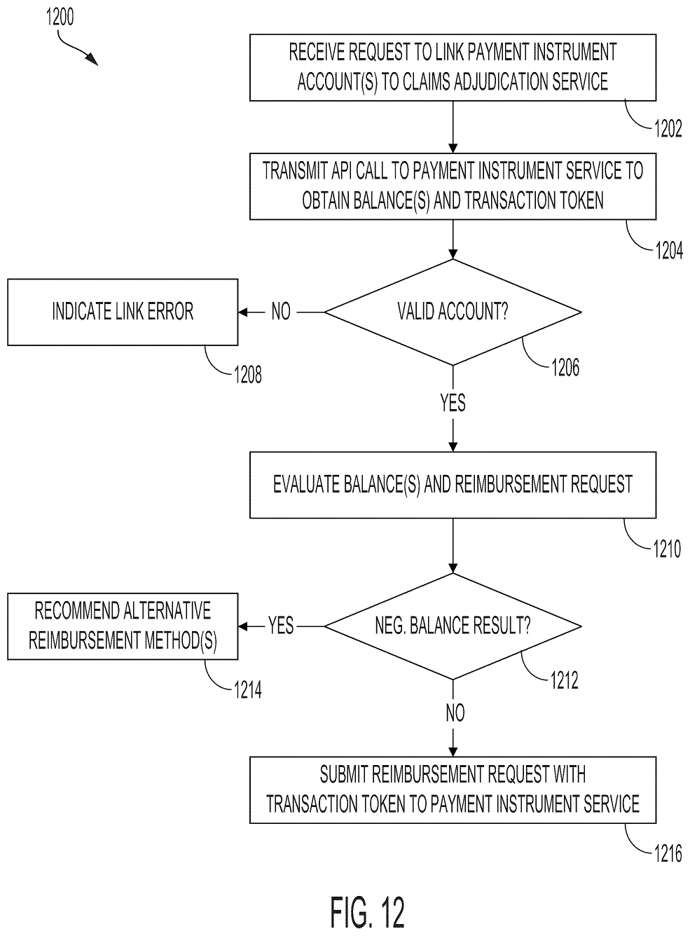

FIG. 12 shows an illustrative example of a process 1200 for generating and submitting a reimbursement request for a claim using an available reimbursement method in accordance with at least one embodiment. The process 1200 may be performed by the claims reimbursement system 104 described above in connection with FIGS. 1-2. Further, the process 1200 may be performed for any payment instrument accounts associated with payment instrument services that may be affiliated with the claims adjudication service or that otherwise allow for determination of account information that may be used to determine whether these payment instrument accounts may be used as reimbursement methods for claims being submitted to the claims adjudication service.

At step 1202, the claims reimbursement system may receive a request to link one or more payment instrument accounts to the claims adjudication service. For instance, when a user accesses the claims adjudication service to submit a claim and a reimbursement request for any upfront payments made to a provider for treatments/procedures performed for an insured entity, the user may select an option to provide account information corresponding to a payment instrument account that the user wishes to link with their claims adjudication service account. For instance, as illustrated in FIGS. 8A and 8B, the claims adjudication service may provide the user with an option 802 to link their payment instrument account associated with a particular payment instrument service to their claims adjudication account. If the user selects this option 802, the claims adjudication service may present, to the user, an account information window 902 (as illustrated in FIG. 9 and through an interface 900) through which the user may provide account information corresponding to their payment instrument account. In some instances, if the user has previously provided account information corresponding to this payment instrument account to the claims adjudication service, the claims adjudication service may present the user with an option (e.g., option 808, as illustrated in FIG. 8C) to select this payment instrument account as their reimbursement method for the claim and corresponding reimbursement request.

At step 1204, the claims reimbursement system may transmit an API call to the payment instrument service associated with the selected payment instrument account to obtain information corresponding to the existing balance for the payment instrument account and an OTB status of the account. This API call may include any available account information associated with the particular payment instrument that may be used by the payment instrument service to identify the target payment instrument account. In some instances, the API call to the payment instrument service may include an access token or other authentication information that may be used by the payment instrument service to authenticate the claims reimbursement system.

As noted above, in response to the API call from the claims reimbursement system, the payment instrument service may return the existing balance (if any) and the OTB status for the particular payment instrument selected by the user. The OTB status associated with the payment instrument account may indicate whether the payment instrument account is active (e.g., the payment instrument account has not been terminated) and available for use (e.g., the payment instrument account has not been frozen or otherwise disabled). Based on the OTB status for the payment instrument account, the claims reimbursement system may determine, at step 1206, whether the account information provided by the user corresponds to a valid account that may be used as a reimbursement method for the reimbursement request. For instance, if the payment instrument account has been terminated or the payment instrument service has no record of an account corresponding to the provided account information, the claims reimbursement system may determine that the account information does not correspond to a valid payment instrument account. Similarly, if the provided account information corresponds to a payment instrument account that is disabled and, thus, unavailable for use, the claims reimbursement system that this payment instrument account cannot be used as a reimbursement method for the present reimbursement request.

If the claims reimbursement system determines that the provided account information does not correspond to a valid payment instrument account or that the corresponding payment instrument account is otherwise unavailable for use, the claims reimbursement system, at step 1208, may indicate a link error. For instance, through the system interface 202 described above in connection with FIG. 2, the claims reimbursement system may inform the user that the account information provided could not be authenticated in the event that the payment instrument service has no record of a corresponding payment instrument account or that the corresponding payment instrument account has been terminated. Similarly, the claims reimbursement system, through the system interface 202, may notify the user that their payment instrument account cannot be used as a reimbursement method if the payment instrument account has been disabled by the payment instrument service.

If the claims reimbursement system determines, based on the OTB response from the payment instrument service, that the payment instrument account indicated by the user is available for use, the claims reimbursement system, at step 1210, may evaluate the existing balance associated with the payment instrument account and the reimbursement request being submitted by the user. As noted above, a reimbursement may be made to a payment instrument account if the reimbursement would not result in the payment instrument account having a negative balance. Accordingly, the claims reimbursement system may compare the existing balance associated with the payment instrument account to the reimbursement amount requested by the user in their claim submission. In some instances, if the user has not indicated a reimbursement amount for their claim, the claims reimbursement system may compare the existing balance associated with the payment instrument account to the upfront payment made by the user and indicated on the invoice submitted by the user for their claim.

At step 1212, based on the evaluation of the existing balance associated with the payment instrument account and the reimbursement amount being requested, the claims reimbursement system may determine whether application of the requested reimbursement amount to this account would result in a negative account balance. If application of the reimbursement amount to the payment instrument account would result in a negative account balance, the claims reimbursement system, at step 1214, may recommend one or more alternative reimbursement methods for the reimbursement request. As noted above, the claims reimbursement system may implement a reimbursement recommendation algorithm that is dynamically trained, in real-time, to generate different reimbursement method recommendations in response to different reimbursement requests. The reimbursement recommendation algorithm may rank any available reimbursement methods associated with the user's claims adjudication service account according to a predicted likelihood of the user selecting each of the available reimbursement methods for the reimbursement request. Further, in some instances, when the user accesses the claims reimbursement system to submit their reimbursement request and the invoice, the reimbursement recommendation algorithm can automatically evaluate any previously recorded reimbursement methods associated with the user's claims adjudication service account to generate an initial set of reimbursement method recommendations. These reimbursement method recommendations may omit the payment instrument account deemed as unavailable for use as a reimbursement method for the present reimbursement request.

If the claims reimbursement system determines that application of the reimbursement amount to the user's payment instrument account would not result in a negative account balance, the claims reimbursement system may submit, at step 1216, a reimbursement request to the payment instrument service. For instance, as noted above, the payment instrument service may return (in response to the account search API call) a transaction token that may be used for any transactions between the claims reimbursement system and the payment instrument service for the particular payment instrument. The claims reimbursement system may transmit an API call to the payment instrument service to request reimbursement of the upfront payment or other indicated amount to the user's payment instrument account. This API call to the payment instrument service may include the transaction token and information corresponding to the reimbursement request submitted by the user. This information may indicate the amount that is to be reimbursed to the user's payment instrument account, the reimbursement payment source (e.g., an account associated with the claims adjudication service, etc.), the claim number and/or other claim details as indicated in the invoice, and the like.

In some instances, the process 1200 may include additional and/or alternative steps. For instance, as noted above, prior to submitting an API call to the payment instrument service to determine the existing balance associated with a selected payment instrument, the claims reimbursement system may query a token vault implemented by the claims adjudication service to determine whether an existing stored token corresponding to the selected payment instrument account is stored within the token vault. The stored token may be provided by the payment instrument service in exchange for a previously generated transaction token associated with the selected payment instrument. If the token vault maintains a valid stored token corresponding to the selected payment instrument, the claims reimbursement system, through the token vault, may submit a request to the payment instrument service to obtain a transaction token for the reimbursement request. This transaction token may then be used in the reimbursement request as part of step 1216.

As another illustrative example of additional and/or alternative steps that may be performed as part of the process 1200, if the claims reimbursement system obtains a transaction token from the payment instrument service as a result of a stored token not being available from the token vault, the claims reimbursement system may exchange the transaction token for a stored token once the reimbursement request has been successfully fulfilled. For instance, in response to receiving a notification from the payment instrument service that the reimbursement request was processed successfully, the claims reimbursement system may transmit an API call to the payment instrument service to exchange the transaction token for a new stored token. This API call may include the transaction token and identifying information corresponding to the claims adjudication service that may be used to authenticate the request. If the payment instrument service successfully authenticates this API call from the claims reimbursement system, the payment instrument service may dynamically generate a stored token that may be used to obtain future transaction tokens for reimbursement requests associated with the corresponding payment instrument account. This new stored token may be stored in the token vault in association with the user's payment instrument account and the user's claims adjudication service account, as described above.

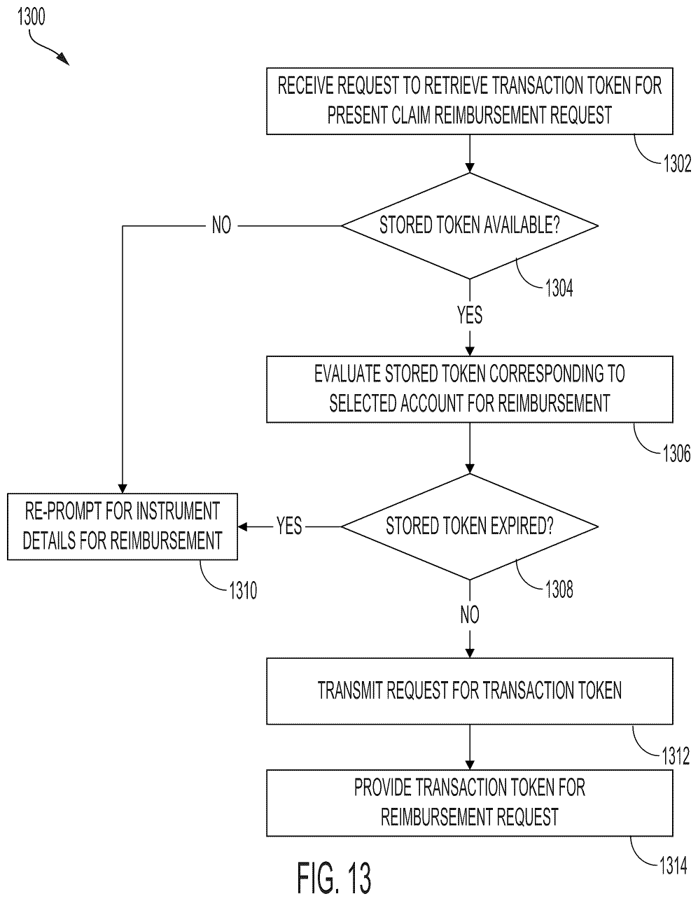

FIG. 13 shows an illustrative example of a process 1300 for obtaining a transaction token corresponding to a selected reimbursement method for submission of a reimbursement request in accordance with at least one embodiment. The process 1300 may be performed by one or more computer systems or processes that maintain a token vault implemented by the claims adjudication service, as described above in connection with FIGS. 1-3. Further, the process 1300 may be performed for any payment instrument accounts associated with payment instrument services that may be affiliated with the claims adjudication service or that otherwise allow for determination of account information that may be used to determine whether these payment instrument accounts may be used as reimbursement methods for claims being submitted to the claims adjudication service.

At step 1302, the token vault may receive a request to retrieve a transaction token for a present reimbursement request associated with a particular payment instrument account. As noted above, prior to submitting an API call to a payment instrument service to determine the existing balance associated with a selected payment instrument account, the claims reimbursement system queries the token vault implemented by the claims adjudication service to determine whether an existing stored token corresponding to the selected payment instrument is stored within the token vault. As noted above, a stored token may be provided by a payment instrument service in exchange for a previously generated transaction token associated with a previously used payment instrument. A stored token may include a tokenized version of a payment instrument associated with the user and may allow for continued retrieval of transaction tokens associated with the corresponding payment instrument. The stored token, in some instances, may be subject to an expiration date, whereby the stored token may be automatically expired once the expiration date has elapsed. The stored token may be stored in the token vault within an entry corresponding to a pairing of the user's claims adjudication service account and the payment instrument or other reimbursement method associated with the stored token. This may allow the claims reimbursement system to use any account information provided in the reimbursement request and/or the selection to query the token vault for a stored token associated with the selected reimbursement method.

At step 1304, the token vault may determine whether a stored token corresponding to indicated payment instrument account is available. For instance, using the account information associated with the payment instrument account and provided in the query from the claims reimbursement system, the token vault may determine whether an entry corresponding to this payment instrument account is maintained within the token vault. If the token vault does not maintain a stored token for the selected payment instrument account, the one or more computer systems or processes that maintain a token vault, at step 1310, may re-prompt the user for account information associated with the selected payment instrument account. The claims reimbursement system may use this re-submitted account information to transmit a request to the payment instrument service to obtain a transaction token that may be used in the reimbursement request, as described above.

If the token vault maintains a stored token associated with the indicated payment instrument account, the token vault, at step 1306 may evaluate the stored token associated with the selected payment instrument account. As noted above, the stored token may be subject to an expiration date, whereby the stored token may be automatically expired once the expiration date has elapsed. This expiration date may be longer (e.g., one year, etc.) than that of a transaction token that is obtained and valid for a single reimbursement transaction. This longer expiration date may allow for continued retrieval of transaction tokens associated with the particular payment instrument without having to repeatedly provide payment instrument account information through API calls to the payment instrument service. Thus, based on this evaluation of the stored token, the one or more computer systems or processes that maintain a token vault may determine, at step 1308, whether the stored token has expired. If the stored token has expired, the one or more computer systems or processes that maintain the token vault, at step 1310, may re-prompt the user for account information associated with the selected payment instrument account.

If the stored token is valid for use (e.g., the stored token is not expired, etc.), the one or more computer systems or processes that maintain the token vault, at step 1312, may transmit a request to the payment instrument service to obtain a transaction token for the reimbursement request. The request may include the stored token previously provided by the payment instrument service. In response to the request, the payment instrument service may evaluate the stored token to determine whether the stored token is valid and is associated with an existing payment instrument account maintained by the payment instrument service. If the payment instrument service determines that the stored token provided in the request is valid, the payment instrument service may generate and issue a transaction token that may be used for the present reimbursement request. This transaction token may be stored in the token vault in association with the entry corresponding to the payment instrument.

At step 1314, the one or more computer systems or processes that maintain the token vault may provide the transaction token to the claims reimbursement system for use in the reimbursement request to the payment instrument service. As noted above, the reimbursement request may be submitted to the payment instrument service through a reimbursement API call to the payment instrument service. This reimbursement API call may include the transaction token and information corresponding to the reimbursement request submitted by the user. In response to the reimbursement API call submitted by the claims reimbursement system, the payment instrument service may process the received transaction token to identify the payment instrument account to which the reimbursement is to be made. The payment instrument service may schedule the reimbursement payment to the payment instrument account, such as through an ACH process whereby the reimbursement amount is obtained from the indicated reimbursement payment source associated with the claims adjudication service and applied to the payment instrument account maintained by the payment instrument service.

It should be noted that, in some instances, the process 1300 may include additional and/or alternative steps. For instance, as noted above, if the token vault does not maintain a stored token corresponding to the payment instrument selected by the user for the reimbursement, the claims reimbursement system may link the user's claims adjudication service account with the payment instrument account by exchanging the transaction token for a new stored token. For instance, in response to receiving a notification from the payment instrument service that the reimbursement request was processed successfully, the claims reimbursement system may transmit an API call to the payment instrument service to exchange the transaction token for a new stored token. This API call may include the transaction token and identifying information corresponding to the claims adjudication service that may be used to authenticate the request. If the payment instrument service 108 successfully authenticates this API call from the claims reimbursement system, the payment instrument service may dynamically generate a stored token that may be used to obtain future transaction tokens for reimbursement requests associated with the corresponding payment instrument. Accordingly, in response to receiving this stored token from the payment instrument service, the one or more computer systems or processes that maintain the token vault may store the stored token within the token vault. Further, the one or more computer systems or processes that maintain the token vault may associate this stored token with the existing entry associated with the pairing of the user's claims adjudication service account and the payment instrument account corresponding to the stored token.

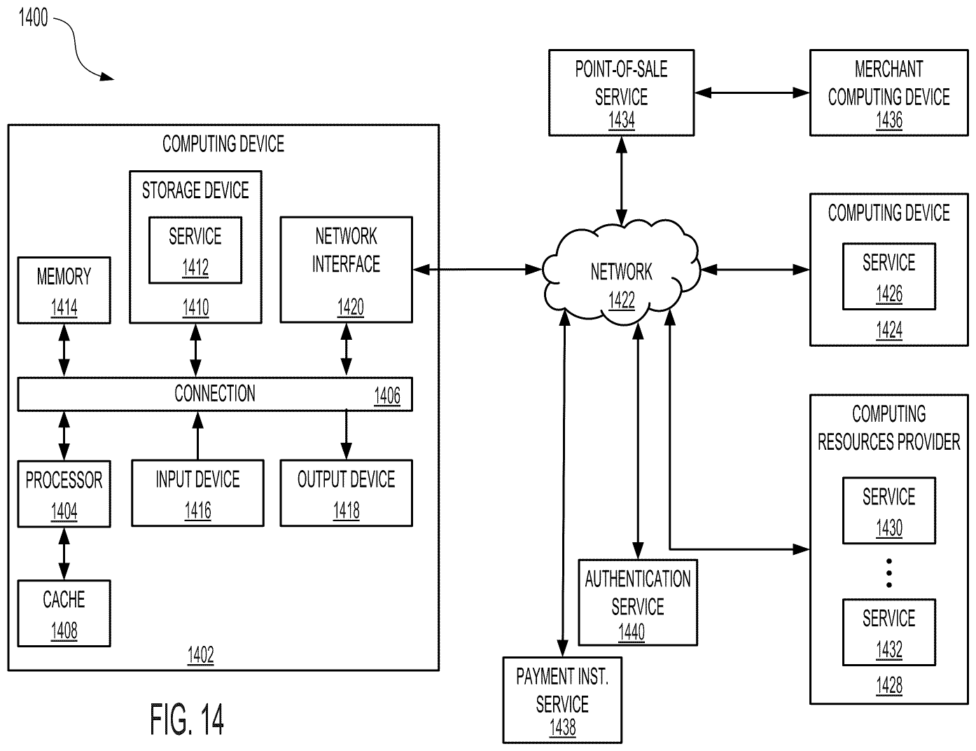

FIG. 14 illustrates a computing system architecture 1400, including various components in electrical communication with each other, in accordance with some embodiments. The example computing system architecture 1400 illustrated in FIG. 14 includes a computing device 1402, which has various components in electrical communication with each other using a connection 1406, such as a bus, in accordance with some implementations. The example computing system architecture 1400 includes a processing unit 1404 that is in electrical communication with various system components, using the connection 1406, and including the system memory 1414. In some embodiments, the system memory 1414 includes read-only memory (ROM), random-access memory (RAM), and other such memory technologies including, but not limited to, those described herein. In some embodiments, the example computing system architecture 1400 includes a cache 1408 of high-speed memory connected directly with, in close proximity to, or integrated as part of the processor 1404. The system architecture 1400 can copy data from the memory 1414 and/or the storage device 1410 to the cache 1408 for quick access by the processor 1404. In this way, the cache 1408 can provide a performance boost that decreases or eliminates processor delays in the processor 1404 due to waiting for data. Using modules, methods and services such as those described herein, the processor 1404 can be configured to perform various actions. In some embodiments, the cache 1408 may include multiple types of cache including, for example, level one (L1) and level two (L2) cache. The memory 1414 may be referred to herein as system memory or computer system memory. The memory 1414 may include, at various times, elements of an operating system, one or more applications, data associated with the operating system or the one or more applications, or other such data associated with the computing device 1402.

Other system memory 1414 can be available for use as well. The memory 1414 can include multiple different types of memory with different performance characteristics. The processor 1404 can include any general purpose processor and one or more hardware or software services, such as service 1412 stored in storage device 1410, configured to control the processor 1404 as well as a special-purpose processor where software instructions are incorporated into the actual processor design. The processor 1404 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1404 can be a microprocessor, a microcontroller, a digital signal processor (“DSP”), or a combination of these and/or other types of processors. In some embodiments, the processor 1404 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1400, an input device 1416 can represent any number of input mechanisms, such as a microphone for speech, a touch-sensitive screen for gesture or graphical input, keyboard, mouse, motion input, pen, and other such input devices. An output device 1418 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1400. In some embodiments, the input device 1416 and/or the output device 1418 can be coupled to the computing device 1402 using a remote connection device such as, for example, a communication interface such as the network interface 1420 described herein. In such embodiments, the communication interface can govern and manage the input and output received from the attached input device 1416 and/or output device 1418. As may be contemplated, there is no restriction on operating on any particular hardware arrangement and accordingly the basic features here may easily be substituted for other hardware, software, or firmware arrangements as they are developed.

In some embodiments, the storage device 1410 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 1410 can include hardware and/or software services such as service 1412 that can control or configure the processor 1404 to perform one or more functions including, but not limited to, the methods, processes, functions, systems, and services described herein in various embodiments. In some embodiments, the hardware or software services can be implemented as modules. As illustrated in example computing system architecture 1400, the storage device 1410 can be connected to other parts of the computing device 1402 using the system connection 1406. In an embodiment, a hardware service or hardware module such as service 1412, that performs a function can include a software component stored in a non-transitory computer-readable medium that, in connection with the necessary hardware components, such as the processor 1404, connection 1406, cache 1408, storage device 1410, memory 1414, input device 1416, output device 1418, and so forth, can carry out the functions such as those described herein.

The disclosed claims adjudication service, the systems of the claims adjudication service, and the systems and methods for dynamically, and in real-time, identifying one or more conditions associated with an obtained invoice can be performed using a computing system such as the example computing system illustrated in FIG. 14, using one or more components of the example computing system architecture 1400. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for dynamically, and in real-time, identifying one or more conditions associated with an obtained invoice described herein by, for example, executing code using a processor such as processor 1404 wherein the code is stored in memory such as memory 1414 as described herein. One or more of a user device, a provider server or system, a database system, or other such devices, services, or systems may include some or all of the components of the computing system such as the example computing system illustrated in FIG. 14, using one or more components of the example computing system architecture 1400 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1428. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1404 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1414 can be coupled to the processor 1404 by, for example, a connector such as connector 1406, or a bus. As used herein, a connector or bus such as connector 1406 is a communications system that transfers data between components within the computing device 1402 and may, in some embodiments, be used to transfer data between computing devices. The connector 1406 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1414 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1414 can also include magnetic or optical data storage media including read-only (e.g., CD ROM and DVD ROM) or otherwise (e.g., CD or DVD). The memory can be local, remote, or distributed.

As described herein, the connector 1406 (or bus) can also couple the processor 1404 to the storage device 1410, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1410. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1406 can also couple the processor 1404 to a network interface device such as the network interface 1420. The interface can include one or more of a modem or other such network interfaces including, but not limited to those described herein. It will be appreciated that the network interface 1420 may be considered to be part of the computing device 1402 or may be separate from the computing device 1402. The network interface 1420 can include one or more of an analog modem, Integrated Services Digital Network (ISDN) modem, cable modem, token ring interface, satellite transmission interface, or other interfaces for coupling a computer system to other computer systems. In some embodiments, the network interface 1420 can include one or more input and/or output (I/O) devices. The I/O devices can include, by way of example but not limitation, input devices such as input device 1416 and/or output devices such as output device 1418. For example, the network interface 1420 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1402 can be connected to one or more additional computing devices such as computing device 1424 via a network 1422 using a connection such as the network interface 1420. In such embodiments, the computing device 1424 may execute one or more services 1426 to perform one or more functions under the control of, or on behalf of, programs and/or services operating on computing device 1402. In some embodiments, a computing device such as computing device 1424 may include one or more of the types of components as described in connection with computing device 1402 including, but not limited to, a processor such as processor 1404, a connection such as connection 1406, a cache such as cache 1408, a storage device such as storage device 1410, memory such as memory 1414, an input device such as input device 1416, and an output device such as output device 1418. In such embodiments, the computing device 1424 can carry out the functions such as those described herein in connection with computing device 1402. In some embodiments, the computing device 1402 can be connected to a plurality of computing devices such as computing device 1424, each of which may also be connected to a plurality of computing devices such as computing device 1424. Such an embodiment may be referred to herein as a distributed computing environment.

The network 1422 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1422 can be wired connections, wireless connections, or combinations thereof. Communications via the network 1422 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1422, within the computing device 1402, within the computing device 1424, or within the computing resources provider 1428 can include information, which also may be referred to herein as content. The information may include text, graphics, audio, video, haptics, and/or any other information that can be provided to a user of the computing device such as the computing device 1402. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1402 and presented to a user of the computing device 1402 using forms that are perceptible via sight, sound, smell, taste, touch, or other such mechanisms. In some embodiments, communications over the network 1422 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1402 and/or the computing device 1424 can be connected to a computing resources provider 1428 via the network 1422 using a network interface such as those described herein (e.g. network interface 1420). In such embodiments, one or more systems (e.g., service 1430 and service 1432) hosted within the computing resources provider 1428 (also referred to herein as within “a computing resources provider environment”) may execute one or more services to perform one or more functions under the control of, or on behalf of, programs and/or services operating on computing device 1402 and/or computing device 1424. Systems such as service 1430 and service 1432 may include one or more computing devices such as those described herein to execute computer code to perform the one or more functions under the control of, or on behalf of, programs and/or services operating on computing device 1402 and/or computing device 1424.

For example, the computing resources provider 1428 may provide a service, operating on service 1430 to store data for the computing device 1402 when, for example, the amount of data that the computing device 1402 exceeds the capacity of storage device 1410. In another example, the computing resources provider 1428 may provide a service to first instantiate a virtual machine (VM) on service 1432, use that VM to access the data stored on service 1432, perform one or more operations on that data, and provide a result of those one or more operations to the computing device 1402. Such operations (e.g., data storage and VM instantiation) may be referred to herein as operating “in the cloud,” “within a cloud computing environment,” or “within a hosted virtual machine environment,” and the computing resources provider 1428 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1428 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 1430 and service 1432 may implement versions of various services (e.g., the service 1412 or the service 1426) on behalf of, or under the control of, computing device 1402 and/or computing device 1424. Such implemented versions of various services may involve one or more virtualization techniques so that, for example, it may appear to a user of computing device 1402 that the service 1412 is executing on the computing device 1402 when the service is executing on, for example, service 1430. As may also be contemplated, the various services operating within the computing resources provider 1428 environment may be distributed among various systems within the environment as well as partially distributed onto computing device 1424 and/or computing device 1402.

In an embodiment, the computing device 1402 can be connected to one or more additional computing devices and/or services such as merchant computing device 1436 and/or a point-of-sale service 1434 via the network 1422 and using a connection such as the network interface 1420. In an embodiment, the point-of-sale service 1434 is separate from the merchant computing device 1436. In an embodiment, the point-of-sale service 1434 is executing on the merchant computing device 1436. In an embodiment, the point-of-sale service 1434 is executing as one or more services (e.g., the service 1430 and/or the service 1432) operating within the environment of the computing resources provider. As used herein, a point-of-sale service 1434 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 1436 to interact with the point-of-sale service 1434. In an embodiment, the merchant computing device 1436 is a dedicated point-of-service (POS) terminal. In an embodiment, the merchant computing device 1436 is a cash register system. In an embodiment, the merchant computing device 1436 is an application or web service operating on a computing device such as the computing device 1402 described herein. In such an embodiment, the application or web service may be provided by a financial services system (e.g., a bank, a transaction processing system, an inventory management system, or some other such financial services system). In an embodiment, the merchant computing device 1436 includes an auxiliary device or system to execute tasks associated with the point-of-sale service 1434 (e.g., a payment instrument processing device attached to a smart phone or tablet). In an embodiment, the merchant computing device 1436 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 1436 is a virtual device (e.g., a virtual kiosk) such as the virtual devices described herein. Although not illustrated here, in an embodiment, the merchant computing device 1436 may be one of a plurality of devices that may be interconnected using a network such as the network 1422.

In an embodiment, the computing device 1402 can be connected to one or more additional computing devices and/or services such as a payment instrument service 1438 via the network 1422 and using a connection such as the network interface 1420. In an embodiment, the payment instrument service 1438 connects directly with the point of sale service 1434. In an embodiment, elements of the payment instrument service 1438 are executing on the merchant computing device 1436. In an embodiment, the payment instrument service 1438 is executing as one or more services (e.g., the service 1430 and/or the service 1432) operating within the environment of the computing resources provider. As used herein, a payment instrument service 1438 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 1438 are running as an application or web service operating on a computing device such as the computing device 1402 described herein. In such an embodiment, the application or web service of the payment instrument service 1438 may be provided by a financial services system (e.g., a bank, a transaction processing system, an inventory management system, or some other such financial services system). In an embodiment, elements of the payment instrument service 1438 are running on an auxiliary device or system configured to execute tasks associated with the payment instrument service 1438 (e.g., uses a payment instrument processing device attached to a smart phone or tablet). In an embodiment, elements of the payment instrument service 1438 are running on virtual device such as those described herein. Although not illustrated here, in an embodiment, the payment instrument service 1438 may be running on one or more of a plurality of devices that may be interconnected using a network such as the network 1422.

In an embodiment, the computing device 1402 can be connected to one or more additional computing devices and/or services such as an authentication service 1440 via the network 1422 and using a connection such as the network interface 1420. In an embodiment, the authentication service 1440 is an element of the payment instrument service 1438. In an embodiment, the authentication service 1440 is separate from the payment instrument service 1438. In an embodiment, the authentication service 1440 connects directly with the point of sale service 1434. In an embodiment, elements of the authentication service 1440 are executing on the merchant computing device 1436. In an embodiment, the authentication service 1440 is executing as one or more services (e.g., the service 1430 and/or the service 1432) operating within the environment of the computing resources provider. As used herein, an authentication service 1440 is a service used by one or more merchants to authenticate transactions associated with payment instruments. An authentication service may be a third-party service that provides secure and verified authorization of the transactions.

In an embodiment, elements of the authentication service 1440 are running as an application or web service operating on a computing device such as the computing device 1402 described herein. In such an embodiment, the application or web service of the authentication service 1440 may be provided by a financial services system (e.g., a bank, a transaction processing system, an inventory management system, or some other such financial services system). In an embodiment, elements of the authentication service 1440 are running on an auxiliary device or system configured to execute tasks associated with the authentication service 1440 (e.g., provides authentication using payment instrument processing device attached to a smart phone or tablet). In an embodiment, elements of the authentication service 1440 are running on virtual device such as those described herein. Although not illustrated here, in an embodiment, the authentication service 1440 may be running on one or more of a plurality of devices that may be interconnected using a network such as the network 1422.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1402) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1402.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112 (f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method, comprising:
receiving a reimbursement request, wherein the reimbursement request includes an invoice and account information corresponding to a payment instrument;
processing the invoice to determine a reimbursement amount for the reimbursement request;
transmitting a balance information application programming interface (API) call corresponding to the reimbursement request, wherein the API call includes the account information;
receiving a transaction token and balance information associated with the payment instrument, wherein the transaction token corresponds to a tokenized version of the payment instrument;
evaluating the reimbursement amount and the balance information to generate a determination, wherein the determination indicates whether fulfillment of the reimbursement request results in a negative balance for the payment instrument, and wherein the determination is generated to prevent transmission of impermissible API calls corresponding to reimbursement requests that would not be fulfilled as a result of the negative balance;
identifying a reimbursement method for the reimbursement request, wherein the reimbursement method is identified based on the determination; and
transmitting a reimbursement API call corresponding to the reimbursement request and according to the reimbursement method, wherein the reimbursement API call includes the transaction token, and wherein when the reimbursement API call is received at a service corresponding to the reimbursement method, the service uses the transaction token to provide the reimbursement amount according to the reimbursement method.

2. The computer-implemented method of claim 1, wherein processing the invoice includes:
generating a digitized version of the invoice, wherein the digitized version of the invoice is generated according to a machine-readable format; and
dynamically evaluating the digitized version of the invoice to determine the reimbursement amount.

3. The computer-implemented method of claim 1, wherein the determination indicates that fulfillment of the reimbursement request does not result in the negative balance for the payment instrument, and wherein when the transaction token is received at the service, the service applies the reimbursement amount to an account associated with the payment instrument.

4. The computer-implemented method of claim 1, further comprising:
transmitting a request to exchange the transaction token for a stored token, wherein the stored token corresponds to a second tokenized version of the payment instrument, and wherein the stored token is exchangeable for new transaction tokens associated with the payment instrument; and
obtaining the stored token, wherein when the stored token is obtained, the transaction token is automatically expired.

5. The computer-implemented method of claim 1, wherein:
the invoice is associated with a policy corresponding to an insured entity; and
the computer-implemented method further comprises identifying a set of reimbursement methods corresponding to the insured entity, wherein the set of reimbursement methods are identified based on the policy.

6. The computer-implemented method of claim 1, wherein the reimbursement method corresponds to a payment method indicated on the invoice.

7. The computer-implemented method of claim 1, wherein receiving the transaction token further includes:
retrieving a stored token, wherein the stored token corresponds to the account information associated with the payment instrument; and
transmitting the stored token, wherein when the stored token is received at a payment instrument service associated with the payment instrument, the payment instrument service provides the transaction token.

8. A system, comprising:
one or more processors; and
memory storing thereon instructions that, as a result of being executed by the one or more processors, cause the system to:
receive a reimbursement request, wherein the reimbursement request includes an invoice and account information corresponding to a payment instrument;
process the invoice to determine a reimbursement amount for the reimbursement request;
transmit a balance information application programming interface (API) call corresponding to the reimbursement request, wherein the API call includes the account information;
receive a transaction token and balance information associated with the payment instrument, wherein the transaction token corresponds to a tokenized version of the payment instrument;
evaluate the reimbursement amount and the balance information to generate a determination, wherein the determination indicates whether fulfillment of the reimbursement request results in a negative balance for the payment instrument, and wherein the determination is generated to prevent transmission of impermissible API calls corresponding to reimbursement requests that would not be fulfilled as a result of the negative balance;
identify a reimbursement method for the reimbursement request, wherein the reimbursement method is identified based on the determination; and
transmit a reimbursement API call corresponding to the reimbursement request and according to the reimbursement method, wherein the reimbursement API call includes the transaction token, and wherein when the reimbursement API call is received at a service corresponding to the reimbursement method, the service uses the transaction token to provide the reimbursement amount according to the reimbursement method.

9. The system of claim 8, wherein the instructions that cause the system to process the invoice further cause the system to:
generate a digitized version of the invoice, wherein the digitized version of the invoice is generated according to a machine-readable format; and
dynamically evaluate the digitized version of the invoice to determine the reimbursement amount.

10. The system of claim 8, wherein the determination indicates that fulfillment of the reimbursement request does not result in the negative balance for the payment instrument, and wherein when the transaction token is received at the service, the service applies the reimbursement amount to an account associated with the payment instrument.

11. The system of claim 8, wherein the instructions further cause the system to:
transmit a request to exchange the transaction token for a stored token, wherein the stored token corresponds to a second tokenized version of the payment instrument, and wherein the stored token is exchangeable for new transaction tokens associated with the payment instrument; and
obtain the stored token, wherein when the stored token is obtained, the transaction token is automatically expired.

12. The system of claim 8, wherein:
the invoice is associated with a policy corresponding to an insured entity; and
the instructions further cause the system to identify a set of reimbursement methods corresponding to the insured entity, wherein the set of reimbursement methods are identified based on the policy.

13. The system of claim 8, wherein the reimbursement method corresponds to a payment method indicated on the invoice.

14. The system of claim 8, wherein the instructions that cause the system to receive the transaction token further cause the system to:
retrieve a stored token, wherein the stored token corresponds to the account information associated with the payment instrument; and
transmit the stored token, wherein when the stored token is received at a payment instrument service associated with the payment instrument, the payment instrument service provides the transaction token.

15. A non-transitory, computer-readable storage medium storing thereon executable instructions that, as a result of being executed by one or more processors of a computer system, cause the computer system to:
receive a reimbursement request, wherein the reimbursement request includes an invoice and account information corresponding to a payment instrument;
process the invoice to determine a reimbursement amount for the reimbursement request;
transmit a balance information application programming interface (API) call corresponding to the reimbursement request, wherein the API call includes the account information;
receive a transaction token and balance information associated with the payment instrument, wherein the transaction token corresponds to a tokenized version of the payment instrument;
evaluate the reimbursement amount and the balance information to generate a determination, wherein the determination indicates whether fulfillment of the reimbursement request results in a negative balance for the payment instrument, and wherein the determination is generated to prevent transmission of impermissible API calls corresponding to reimbursement requests that would not be fulfilled as a result of the negative balance;
identify a reimbursement method for the reimbursement request, wherein the reimbursement method is identified based on the determination; and
transmit a reimbursement API call corresponding to the reimbursement request and according to the reimbursement method, wherein the reimbursement API call includes the transaction token, and wherein when the reimbursement API call is received at a service corresponding to the reimbursement method, the service uses the transaction token to provide the reimbursement amount according to the reimbursement method.

16. The non-transitory, computer-readable storage medium of claim 15, wherein the executable instructions that cause the computer system to process the invoice further cause the computer system to:
generate a digitized version of the invoice, wherein the digitized version of the invoice is generated according to a machine-readable format; and
dynamically evaluate the digitized version of the invoice to determine the reimbursement amount.

17. The non-transitory, computer-readable storage medium of claim 15, wherein the determination indicates that fulfillment of the reimbursement request does not result in the negative balance for the payment instrument, and wherein when the transaction token is received at the service, the service applies the reimbursement amount to an account associated with the payment instrument.

18. The non-transitory, computer-readable storage medium of claim 15, wherein the executable instructions further cause the computer system to:
transmit a request to exchange the transaction token for a stored token, wherein the stored token corresponds to a second tokenized version of the payment instrument, and wherein the stored token is exchangeable for new transaction tokens associated with the payment instrument; and
obtain the stored token, wherein when the stored token is obtained, the transaction token is automatically expired.

19. The non-transitory, computer-readable storage medium of claim 15, wherein:
the invoice is associated with a policy corresponding to an insured entity; and
the executable instructions further cause the computer system to identify a set of reimbursement methods corresponding to the insured entity, wherein the set of reimbursement methods are identified based on the policy.

20. The non-transitory, computer-readable storage medium of claim 15, wherein the reimbursement method corresponds to a payment method indicated on the invoice.

21. The non-transitory, computer-readable storage medium of claim 15, wherein the executable instructions that cause the computer system to receive the transaction token further cause the computer system to:
retrieve a stored token, wherein the stored token corresponds to the account information associated with the payment instrument; and
transmit the stored token, wherein when the stored token is received at a payment instrument service associated with the payment instrument, the payment instrument service provides the transaction token.
